(19) United States
(12) Patent Application Publication
(10) Pub. No.: US 2026/0245048 A1
(43) Pub. Date: Aug. 20, 2026

(54) PARALLELIZED MULTI-OBJECTIVE PROGRAMMING FOR COMPLEX SCHEDULING OPTIMIZATION

(71) Applicant: SAUDI ARABIAN OIL COMPANY, Dhahran (SA)

(72) Inventors: Zeeshan Malik, Dhahran (SA); Ali Abusnina, Dhahran (SA); Nouman Riaz Khan, Khobar (SA)

(73) Assignee: SAUDI ARABIAN OIL COMPANY, Dhahran (SA)

(21) Appl. No.: 19/057,150

(22) Filed: Feb. 19, 2025

(51) Int. Cl. G06Q 10/20

(52) U.S. Cl. CPC G06Q 10/20

(57) ABSTRACT

A method that includes obtaining a minimum deactivation time for each processing device of a processing system configured to produce one or more materials and operate in accordance with a deactivation schedule. The deactivation schedule includes a calendared deactivation period for each processing device. The method further includes obtaining a maximum turnaround time for the processing system, obtaining a set of conditions for the deactivation schedule and determining, subject to the set of conditions, an optimum deactivation schedule by optimizing a production objective. The conditions require that the calendared deactivation period of each processing device lasts at least the minimum deactivation time, and a total duration of the deactivation schedule does not last longer than the maximum turnaround time. The conditions also seek to reduce overlap between calendared deactivation periods. The method further includes performing a system maintenance of the processing system according to the optimum deactivation schedule.

### BACKGROUND

In oil refineries and gas processing plants, production materials such as fuels are produced from raw hydrocarbons using various processing units. To ensure continuous and efficient production, the processing units undergo maintenance activities. During maintenance, a processing unit is temporarily shut down, which may impact overall production.

To mitigate the impact on the overall production, shutdown schedules of the various processing units can be carefully planned to ensure that there is always an adequate number of operational processing units to meet the production demand. Generally, determining shutdown schedules is a resource intensive, empirical process based on experience, which does not always result in the most favorable production outcome.

Accordingly, there is a need for an automated method for determining shutdown schedules that optimize the production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method that includes obtaining, for each processing device of a plurality of processing devices of a processing system, a minimum deactivation time associated with the processing device. The processing system is configured to produce one or more materials and operate in accordance with a deactivation schedule. The deactivation schedule includes, for each processing device in the plurality of processing devices, a calendared deactivation period associated with the processing device, during which the processing device is deactivated. The method further includes obtaining a maximum turnaround time for the processing system, obtaining a set of conditions for the deactivation schedule and determining, subject to the set of conditions, an optimum deactivation schedule for the processing system, the determination including optimizing a production objective based on a production of the one or more materials. The set of conditions includes a deactivation period condition that, for each processing device in the plurality of processing devices, a duration of the calendared deactivation period of the processing device is no less than the minimum deactivation time associated with the processing device. The set of conditions further includes a turnaround condition that a total duration of the deactivation schedule does not exceed the maximum turnaround time, and a stateful non-overlap condition that, at least, reduces overlap between calendared deactivation periods. The method further includes performing a system maintenance of the processing system according to the optimum deactivation schedule.

In one aspect, embodiments disclosed herein relate to a system that includes a processing system, a computer and a service system. The processing system includes a plurality of processing devices. The processing system is configured to produce one or more materials and operate in accordance with a deactivation schedule. The deactivation schedule includes, for each processing device in the plurality of processing devices, a calendared deactivation period associated with the processing device, during which the processing device is deactivated. The computer includes one or more computer processors, configured to receive, for each processing device of the plurality of processing devices, a minimum deactivation time associated with the processing device. The one or more computer processors are further configured to receive a maximum turnaround time for the processing system, receive a set of conditions for the deactivation schedule, and determine, subject to the set of conditions, an optimum deactivation schedule for the processing system, the determination including optimizing a production objective based on a production of the one or more materials. The set of conditions includes a deactivation period condition that, for each processing device in the plurality of processing devices, a duration of the calendared deactivation period of the processing device is no less than the minimum deactivation time associated with the processing device. The set of conditions further includes a turnaround condition that a total duration of the deactivation schedule does not exceed the maximum turnaround time, and a stateful non-overlap condition that, at least, reduces overlap between calendared deactivation periods. The service system is configured to perform a system maintenance of the processing system according to the optimum deactivation schedule.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 displays an oil refinery, in accordance with one or more embodiments disclosed herein.

FIG. 2 depicts a block diagram of a system for computing a production based on a deactivation schedule, in accordance with one or more embodiments disclosed herein.

FIG. 3 depicts a block diagram of a system for computing an optimum deactivation schedule and performing a system maintenance, in accordance with one or more embodiments disclosed herein.

FIG. 4 depicts a block diagram of a system for computing an optimum deactivation schedule and performing a system maintenance, in accordance with one or more embodiments disclosed herein.

FIG. 5 depicts a block diagram of a multi-stage optimizer, in accordance with one or more embodiments disclosed herein.

FIG. 6 depicts a block diagram of a system for computing an optimum deactivation schedule and performing a system maintenance, in accordance with one or more embodiments disclosed herein.

FIG. 7 depicts a flow chart of a method for computing an optimum deactivation schedule and performing a system maintenance, in accordance with one or more embodiments disclosed herein.

FIG. 8 depicts an example diagram of a computer, in accordance with one or more embodiments disclosed herein.

FIG. 9A displays a bar plot, in accordance with one or more embodiments disclosed herein.

FIG. 9B displays a bar plot, in accordance with one or more embodiments disclosed herein.

FIG. 9C displays a bar plot, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

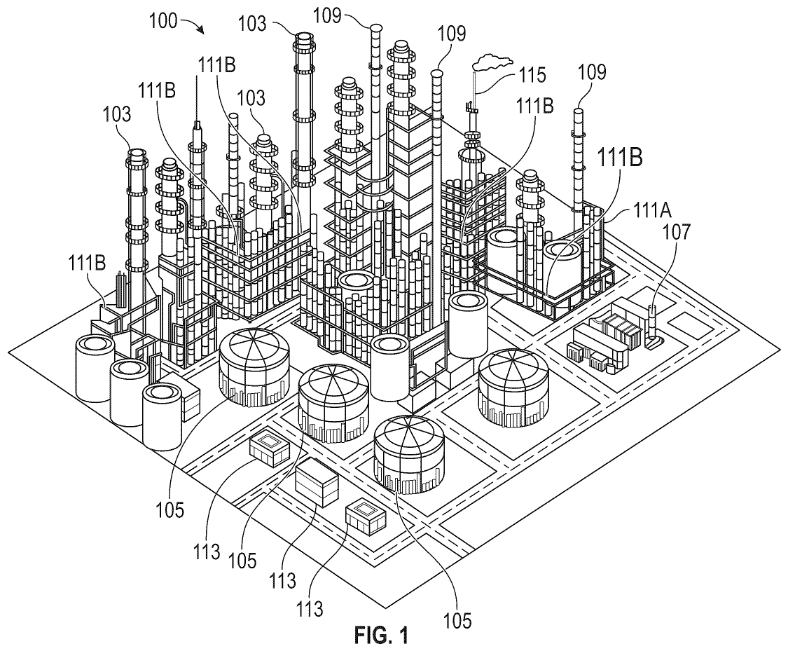

In the following description of FIGS. 1-9C, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein generally relate to a workflow for optimization of the complete cycle for shutdown planning for turnaround and inspection of production units. Entire production units are shut-down for disassembly, comprehensive inspection and renewal. The complete cycle has a plurality of phases, and as described herein, all the phases for optimization happen in a parallelized stateful manner. Specifically, methods and systems are disclosed for determining optimum deactivation schedules that optimize the production of materials in a processing system. Examples of such a processing system include, but are not limited to, an oil refinery, a gas processing plant, as well as a plurality of oil refineries or gas processing plants. Yet, methods and systems disclosed herein may be used in relation to any processing system that includes a plurality of processing devices that need to be temporarily deactivated. The methods and systems disclosed further include performing a maintenance activity of the processing devices while they are deactivated in accordance with the optimum deactivation schedule. Advantageously, the methods and system disclosed are automated and may be run on a readily available desktop or laptop computers without the need for an extensive computational system. Advantageously, the methods and systems disclosed may be applied to existing processing systems, without the need for installing any new equipment. Advantageously, the methods and systems disclosed may be customized by subjecting the optimization of the deactivation schedule to a selected set of conditions. Advantageously, the methods and systems disclosed may be used to optimize the production of materials in a processing system.

FIG. 1 depicts an oil refinery (100) as an example of a processing system. The oil refinery (100) transforms raw hydrocarbons through a plurality of processing devices in order to produce production materials including, for example, various types of fuel. Oil refineries may be configured in a myriad of ways. Therefore, the oil refinery (100) is not intended to be limiting with respect to the particular configuration in FIG. 1. The oil refinery (100) includes a plurality of processing devices, such as a plurality of fractionating towers (103), a plurality of crude oil tanks (105), a catalytic cracking unit (107), a plurality of chimneys (109), pluralities of connecting pipes (111a-b), a plurality of waste management systems (113) and a flaring device (115). The oil refinery (100) may include other components not depicted in FIG. 1, such as heat exchangers, compressors, accumulators, boilers, pumps, inlet separators, coolers, evaporators, plant sensors, plant instruments, gauges, control switches, valves, emergency stop controls, pressure relief equipment, smoke detectors, toxic gas detectors, thermal detectors, combustible gas detectors, electric power generators, turbines, exhaust fans, light panels, fume scrubbers and safety showers. Oil refineries may further include a different number of fractionation towers, catalytic cracking units or connecting pipes from the ones in FIG. 1.

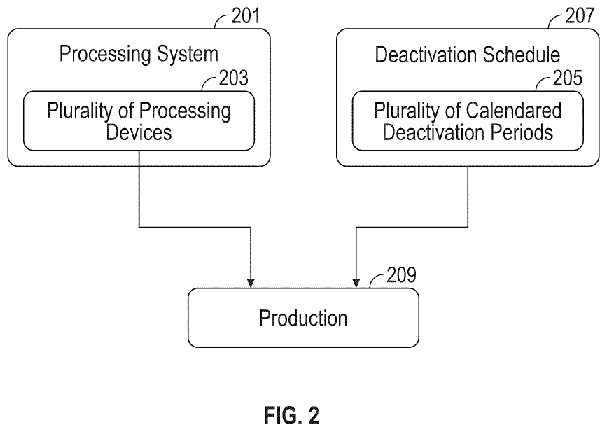

FIG. 2 depicts a system for computing amounts of materials produced by a processing system (201) during a certain period. The processing system (201) includes a plurality of processing devices (203), denoted as Uᵢ, for i=1, . . . , n, where n≥1 is the number of processing devices in the plurality of processing devices (203). The plurality of processing devices (203) is configured to produce one or more materials as outputs, denoted as Mᵢ, for i=1, . . . , m, where m≥1 is the number of materials in the one or more materials. The one or more materials Mᵢ include production materials. Production materials are defined as materials produced for a benefit, such as materials to be used as an energy source, construction materials, materials sold for a revenue, or any combination thereof. In some embodiments, the one or more materials further include waste materials. Waste materials are defined as by-products of processes performed for producing the production materials. Generally, it is preferable for the processing system (201) to produce the least possible amount of waste materials.

The processing system (201) may be defined in many ways. Examples of the processing system (201) include an oil refinery, a gas processing plant or a chemical plant. In some embodiments, the processing system (201) is an oil refinery, such as the oil refinery (100) in FIG. 1, and the plurality of processing devices (203) include one or more fractionating towers, storage tanks, catalytic cracking units, or any combination thereof. The oil refinery produces one or more production materials, such as gasoline, diesel fuel, asphalt base, heating oil, kerosene and liquefied petroleum gas. In some embodiments, the oil refinery produces waste materials, such as hydrogen sulfide. In some embodiments, the processing system (201) is a gas processing plant, and the plurality of processing devices (203) may include fractionating towers, gas sweeteners, ethane recovery units, or any combination thereof. The gas processing plant produces one or more production materials, such as methane, ethane, and natural gas liquids. In some embodiments, the gas processing plant produces waste materials, such as hydrogen sulfide. In some embodiments, the processing system (201) is a chemical plant, and the plurality of processing devices (203) may include reactors, distillation columns, compressors, or any combination thereof. The chemical plant produces one or more production materials, such as polymers. In some embodiments, the chemical plant produces waste materials, such as wastewater, dioxins, or solvent waste. Examples of the processing system (201) further include any combination of one or more oil refineries, one or more gas processing plants and one or more chemical plants. In such scenarios, the plurality of processing devices (203) includes processing devices of the combination of the one or more oil refineries, one or more gas processing plants and one or more chemical plants. In such scenarios, the one or more materials include the materials produced by the combination of the one or more oil refineries, one or more gas processing plants and one or more chemical plants. In such scenarios, the combination of the one or more oil refineries, one or more gas processing plants and one or more chemical plants may be said to form a single processing system.

The processing system (201) produces each of the one or more materials at a certain specific material production rate, thereby resulting in one or more material production rates. Generally, the one or more material production rates depend on a process flow that connects the plurality of processing devices (203). In one or more embodiments, the material production rate, for each of the one or more materials, is defined as an amount of the material produced during a certain period, divided by a duration of the period. In this disclosure, a production period is a predefined interval of time during which the processing system (201) is operated. The production period may be defined, for example, as a specific month of the year, a specific quarter, a specific year or specific decade. During a production period, a turnaround operation occurs. The turnaround operation is a process of deactivating a set of processing devices (where the set may include all the processing devices) in the plurality of processing devices (203) for a certain amount of time, specific to the processing device. While deactivated, a processing device may undergo maintenance. Thus, during the production period, each processing device may be assigned a status of “active” or “inactive”. Deactivating any processing device may affect the process flow and thus, the one or more material production rates. At a given time, the one or more material production rates depend on the processing devices with an “active” status. Equivalently, at a given time, the one or more material production rates depend on the processing devices with an “inactive” status.

During the production period, each processing device Uᵢ in a designated set is deactivated during a certain calendared deactivation period, denoted as Sᵢ, associated with the processing device Uᵢ, for i=1, . . . , n. The calendared deactivation periods of the set of processing devices in the plurality of processing devices (203) form a plurality of calendared deactivation periods (205). The production of each the one or more materials during the production period is a function of the calendared deactivation periods of the processing devices. Each calendared deactivation period Sᵢ includes a time interval, [aᵢ, bᵢ], during which the processing device Uᵢ is deactivated, for i=1, . . . , n. For each time interval, [aᵢ, bᵢ], aᵢ is called a start time of the calendared deactivation period and bᵢ is called an end time of the calendared deactivation period, with bᵢ>aᵢ, for i=1, . . . , n. For of each processing device Uᵢ, a deactivation time Tᵢ is defined as a duration of the calendared deactivation period Sᵢ, so that Tᵢ:=bᵢ-aᵢ, for i=1, . . . , n. The plurality of calendared deactivation periods (205) forms a deactivation schedule (207) of the processing system (201), the deactivation schedule (207) denoted as S:={Sᵢ, i=1, . . . , n}. Thus, the production of each of the one or more materials during the production period is a function of the deactivation schedule (207). A duration of the turnaround operation is defined as a total duration of the deactivation schedule (207), namely, T=bₗₐₛₜ−α_{first}, where bₗₐₛₜ is the end time of the calendared deactivation period for the last processing device in the deactivation schedule (or the processing device with the latest calendared deactivation period) and α_{first} is the start time of the calendared deactivation period for the first processing device in the deactivation schedule (or the processing device with the first calendared deactivation period).

In one or more embodiments, the production of each material Mᵢ is computed using a production function, Pᵢ, that receives the deactivation schedule S as input, for i=1, . . . , m:

$$S \to {P}_{i} ( S ) . \qquad EQ . 1$$

In EQ. 1, Pᵢ(S) is a production of the material Mᵢ, defined as the quantity of material Mᵢ produced during the production period. EQ. 1 defines one or more productions Pᵢ(S). The one or more productions Pᵢ(S) form a production (209) of the processing system (201) during a production period. The production (209) is based on the deactivation schedule (207). Thus, selecting a deactivation schedule (207) may have a significant effect on the production (209). For example, in some embodiments, the longer the deactivation time Tᵢ of a processing device Uᵢ contributing to the production of a material Mᵢ, the smaller the production of the material Mᵢ during the production period. As another example, the production rate of each material may be affected by which processing devices are deactivated simultaneously. Thus, the production (209) may be affected by whether some of the calendared deactivation periods Sᵢ overlap, and by how much they overlap. In some embodiments, the production of a material may be reduced or halted during a certain time due to the deactivation schedule (207).

Generally, the deactivation schedule (207) is defined based on prior experience or education of one or more specialists, in accordance with a deactivation strategy. In some embodiments, the deactivation schedule (207) is selected based on qualitative criteria. For instance, in some scenarios, the deactivation schedule (207) is selected such that the production of a given material is never halted during the turnaround operation. In other scenarios, the deactivation schedule (207) is selected by attempting to reduce the overlap of some of the calendared deactivation periods. In some scenarios, the one or more specialists try to determine the deactivation schedule (207) in order to maintain the production (209) above a certain pre-defined threshold. Generally, defining a deactivation schedule (207) may be a difficult task for humans to perform, owing, at least in part, to three criteria. Firstly, in some embodiments, the number of unknowns to be determined is considered as large. For instance, in embodiments where the processing system includes two hundred processing devices, the number of start-times and end-times for the calendared deactivation periods of the processing devices is also two hundred, which may be considered as large, in accordance with one or more embodiments. Secondly, the relationship between the deactivation schedule (207) and the production (209) may be non-linear, based on a process flow connecting the multiple processing devices. Thirdly, criteria for giving preference to a first a deactivation schedule compared to a second deactivation schedule may be defined in many ways. Thus, the choice of the deactivation schedule (207) may be subjective to the one or more specialists defining the deactivation schedule (207), and therefore, dependent on who defines the deactivation schedule (207). Advantageously, embodiments disclosed herein offer automated methods and systems for optimizing the deactivation schedule (207) based on the production (209) and a plurality of conditions.

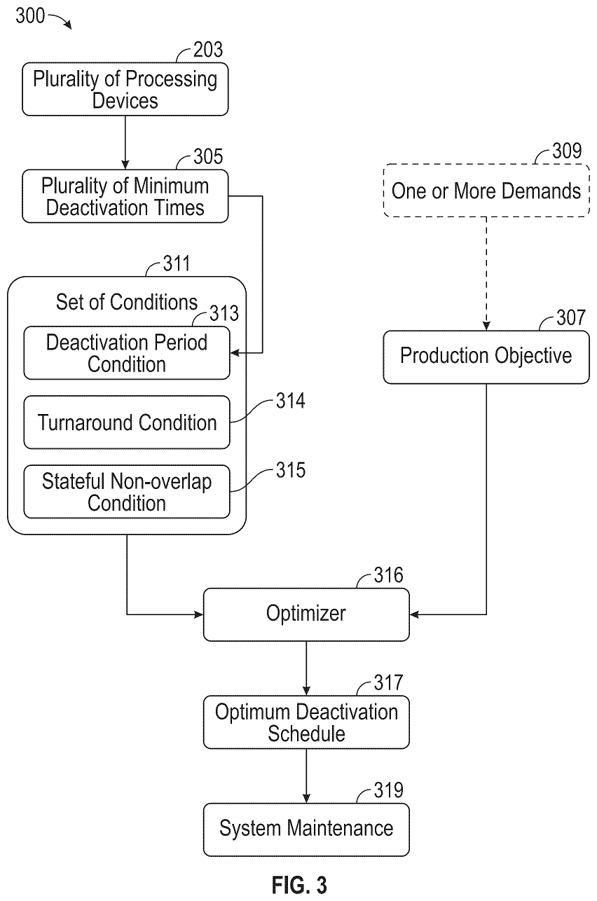

FIG. 3 depicts a system (300) for optimizing the deactivation schedule (207) of the processing system (201), based on optimizing a production objective (307), subject to a set of conditions (311) for the deactivation schedule (207). Generally, a maintenance activity requires a certain amount of time to be performed for a processing device. Thus, any processing device slated for deactivation is required to be deactivated long enough for the maintenance activity to be performed. In that regard, a minimum deactivation time, Dᵢ, is received for each processing device Uᵢ, for i=1, . . . , n. The minimum deactivation times Dᵢ, for i=1, . . . , n, form a plurality of minimum deactivation times (305) in FIG. 3. In one or more embodiments, each minimum deactivation time Dᵢ is an expected amount of time taken to perform a maintenance activity for the processing device Uᵢ, for i=1, . . . , n.

Determining the optimum deactivation schedule (317) is subject to the set of conditions (311). The set of conditions (311) includes a deactivation period condition (313) that the deactivation time Tᵢ=bᵢ−aᵢ of each processing device Uᵢ, i=1, . . . , n, be at least equal to the minimum deactivation time Dᵢ associated with the processing device. In other words, the deactivation period condition (313) is defined as bᵢ−aᵢ≥Dᵢ, for i=1, . . . , n. It is noted that the deactivation period condition (313) does not preclude the deactivation time Tᵢ to be greater than the minimum deactivation time Dᵢ. The set of conditions (311) further includes a turnaround condition (314). The turnaround condition (314) is a requirement that the duration of the total duration of the deactivation schedule (207), T, does not exceed a pre-defined maximum turnaround time Tₘₐₓ, which means T≤Tₘₐₓ. The maximum turnaround time is received by the processing system (201). In one or more embodiments, the maximum turnaround time is defined, received from, or both, by a stakeholder of the processing system (201). Examples of stakeholders of the processing system (201) include a manager of the processing system (201), an operator of the processing system (201), a user of the processing system (201), a client of the processing system (201), and an entity performing maintenance of the plurality of processing devices (203). In some embodiments, the maximum turnaround time is based on an availability of maintenance equipment.

The set of conditions (311) further includes a stateful non-overlap condition (315). The stateful non-overlap condition (315) includes seeking to reduce the overlap of the calendared deactivation periods of pairs of processing devices within a pre-defined subset of the processing devices Uᵢ. Advantageously, reducing the overlap of the calendared deactivation periods of two processing devices means that the amount of time that the two processing devices are deactivated simultaneously is reduced. In some implementations, one or more of the productions Pᵢ(S) in EQ. 1 decrease with an increase of the overlap between the calendared deactivation periods of two processing devices within the subset. Thus, in such implementations, reducing the overlap between the calendared deactivation periods of two processing devices within the subset results in an increase of the production of a material, which may be advantageous in some situations. In other words, in some implementations, preventing two specific processing devices from being deactivated simultaneously increases one or more of the productions Pᵢ(S) in EQ. 1. Further, in some implementations, it may be advantageous or required that two specified processing devices are not deactivated simultaneously (or with overlap in their deactivation periods), for example, to properly perform maintenance activities on the specified processing devices. For example, a limit on maintenance equipment or personnel can necessitate that two specified processing devices do not have overlapping calendared deactivation periods. Thus, in some implementations, the pairs of processing devices subject to the stateful non-overlap condition are pre-defined in order to increase one or more of the productions Pᵢ(S) in EQ. 1. In some implementations, the pairs of processing devices subject to the stateful non-overlap condition includes all possible pairs of processing devices from the whole set {Uᵢ, i=1, . . . , n}, meaning that the stateful non-overlap condition (315) includes seeking to reduce the overlap of the calendared deactivation periods of any pair of the processing devices in the processing system (201) (or the set of processing devices selected for deactivation). The set of conditions (311) may further include further conditions defined later in this disclosure.

The optimum deactivation schedule (317) is determined by optimizing the production objective (307). The production objective (307) is based on the one or more productions Pᵢ (S), for i=1, . . . , m. Optimizing the production objective (307) may be defined in many ways. In one or more embodiments, optimizing the production objective (307) includes seeking to maximize, over S, the productions Pᵢ of a first subset of one or more materials denoted as M¹:={Mᵢ, i∈I₁}, where I₁ is a first subset of [1, . . . , m]. As previously stated, the one or more materials Mᵢ may include waste materials. In such scenarios, optimizing the production objective (307) may include seeking to minimize, over S, the productions Pᵢ of a second subset of one or more waste materials, denoted as M²:={Mᵢ, i∈I₂}, where Is is a second subset of [1, . . . , m] such that I₁∩I₂=Ø. In some embodiments, the production objective (307) includes one or more productions Pᵢ(S) for i∈I₁∪I₂ and optimizing the production objective (307) includes both of seeking to maximize the productions Pᵢ for i∈I₁ and seeking to minimize the productions Pᵢ for i∈I₂.

In one or more embodiments, a demand dᵢ exists for a third subset of materials M³:={Mᵢ, i∈I₃}, where I₃ is a third subset of [1, . . . , m] such that I₁∩I₂∩I₃=Ø, resulting in one or more demands (309). Advantageously, the third subset of materials may include production materials for which the demand dᵢ satisfies a need in an industry. For example, in some embodiments, a demand may exist for a type of gasoline to fuel cars of a population in a given area, and the type gasoline is a first example production material from the processing system (201). As another example, a demand may exist for kerosene to fuel airplanes for a group of one or more airlines and kerosene is a second example production material from the processing system (201). In one or more embodiments, the one or more demands dᵢ are received by a stakeholder of the processing system (201). Examples of stakeholders of the processing system (201) are defined earlier in this disclosure. For each material Mᵢ such that i∈I₃, the demand dᵢ may be defined as a quantity of the material Mᵢ desirable to be produced during the production period. For i∈I₃, a mismatch between the production of the material Mᵢ and the demand dᵢ is defined as:

$$γ ( {d}_{i} , {P}_{i} ( S ) ) . \qquad EQ . 2$$

In EQ. 2, γ is a mathematical quasi-distance, meaning that for all x, y, z, γ(x, y)≥0, γ(x,x)=0 and γ(x,z)≤γ(x,z)+γ(z, y). In some embodiments, optimizing the production objective (307) may include seeking to minimize, over S, the one or more mismatches γ(dᵢ, Pᵢ(S)), for i∈I₃.

In some implementations, the mismatch from EQ. 2 is defined as an absolute value of the difference:

$$γ ( {d}_{i} , {P}_{i} ( S ) ) = \vert {d}_{i} - {P}_{i} ( S ) \vert . \qquad EQ . 3$$

In such implementations, seeking to minimize the one or more mismatches γ(dᵢ, Pᵢ(S)) may be interpreted as trying to match each of the one or more productions Pᵢ(S) with the corresponding demand dᵢ, for i∈I₃. In other words, seeking to minimize the one or more mismatches γ(dᵢ, Pᵢ(S)) may be interpreted as seeking a deactivation schedule S such that the production Pᵢ(S) neither underperforms nor overperforms the demand dᵢ, for i∈I₃. Thus, in some embodiments, EQ. 3 may intentionally prevent the one or more productions Pᵢ(S), i∈I₃, from being maximized during the minimization of the one or more mismatches γ(dᵢ, Pᵢ(S)). In contrast, in other implementations, the mismatch from EQ. 2 is defined based on the positive part of dᵢ−Pᵢ(S):

$$γ ( {d}_{i} , {P}_{i} ( S ) ) = max ( {d}_{i} - {P}_{i} ( S ) , 0 ) . \qquad EQ . 4$$

In such implementations, seeking to minimize the one or more mismatches γ(dᵢ, Pᵢ(S)) may be interpreted as trying to enforce one or more productions Pᵢ(S) to, at least, meet the corresponding demand dᵢ. However, seeking to minimize the one or more mismatches Y (dᵢ, Pᵢ(S)) as defined in EQ.4 does not prevent each of the one or more productions Pᵢ(S) from exceeding the demand dᵢ. In fact, the definition of the mismatch in EQ.4 does not seek to impose an upper limit to each of the one or more productions Pᵢ(S). Thus, the mismatch is EQ.4 is configured to allow each of the one or more productions Pᵢ(S) to exceed the demand dᵢ without an upper limit.

It is noted that only one of the first, second and third subsets of one or more materials, M¹, M² and M³, needs to exist in the present disclosure. In other words, in some embodiments, one or two of the subsets M¹, M² and M³ may be empty. For instance, in some specific embodiments, the subsets M² and M³ are empty, which implies that M¹ includes all of the one or more materials, i.e. I₁=[1, . . . , m]. In such embodiments, all of the one or more materials are production materials and optimizing the production objective (307) includes seeking to maximize the productions of all of the one or more materials. In other specific embodiments, the subsets M¹ and M² are empty, which implies that M³ includes all of the one or more materials, i.e. I₃=[1, . . . , m]. In such embodiments, a demand is received for each of the one or more materials and optimizing the production objective (307) includes seeking to minimize the one or more mismatches between the production and demand of each of the one or more materials. In other specific embodiments, the subsets M¹ and M³ are empty, which implies that M² includes all of the one or more materials, i.e. I₂=[1, . . . , m]. In such embodiments, all of the one or more materials are waste materials and optimizing the production objective (307) includes seeking to minimize the productions of all of the one or more materials. In other specific embodiments, the subset M² empty and the subsets M¹ and M³ are not empty, which implies that a union of M¹ and M³ includes all of the one or more materials, i.e. I₁∪I₃=[1, . . . , m]. In such embodiments, a demand is received for each of the one or more materials in M³. In such embodiments, optimizing the production objective (307) includes seeking to maximize the productions of the one or more materials in M¹ and seeking to minimize the one or more mismatches between the production and demand of each of the one or more materials in M³.

The optimum deactivation schedule (317) is determined using an optimizer (316) configured to optimize the production objective (307) subject to the set of conditions (311). The optimum deactivation schedule (317) is denoted as S*. The optimum deactivation schedule (317) includes a plurality of components including, for each processing device Uᵢ, i=1, . . . , n, a calendared deactivation period, denoted as

$${S}_{i}^{★} ,$$

called an optimum calendared deactivation period. Each optimum calendared deactivation period

$${S}_{i}^{★}$$

includes a time interval,

$$[ {a}_{i}^{★} , {b}_{i}^{★} ] , with {a}_{i}^{★} < {b}_{i}^{★} , for i = 1 , ... , n .$$

For each for i=1, . . . , n, a duration of the optimum calendared deactivation period

$${S}_{i}^{★}$$

is called an optimum deactivation time

$${T}_{i}^{★}$$

associated with the processing device Uᵢ, defined as the length of the time interals

$$[ {a}_{i}^{★} , {b}_{i}^{★} ] : {T}_{i}^{★} := {b}_{i}^{★} - {a}_{i}^{★} .$$

The optimum calendared deactivation periods

$${S}_{i}^{⋆}$$

satisfy the deactivation period condition (313) and the turnaround condition (314). In particular, for each i=1, . . . , n, the optimum deactivation time

$${T}_{i}^{⋆}$$

is greater than or equal to the minimum deactivation time

$${D}_{i} : {T}_{i}^{⋆} \geq {D}_{i} .$$

Furthermore, the duration of the turnaround operation does not exceed the maximum turnaround time Tₘₐₓ. The optimizer (316) may be defined in many ways, some of which are defined later in this disclosure.

A system maintenance (319) is performed in accordance with the optimum deactivation schedule (317). The system maintenance (319) includes performing, for each processing device Uᵢ, one or more maintenance activities during the optimum calendared deactivation periods

$${S}_{i}^{⋆} ,$$

while the processing device Uᵢ is deactivated. Maintenance activities may be of several types. Examples of maintenance activities that may be performed for a processing device include, but are not limited to, an inspection of the processing device, a cleaning of the processing device, a tuning of the processing device and a repair of the processing device, such as, for example, replacing a part of the processing device. In one or more embodiments, the system maintenance (319) is performed by a service system. The service system may include one or more departments, such as an engineering department, a human resource department, a construction department, a maintenance department, a mechanical department, a legal department, a sales department, a research and development department and a Health, Safety and Environment (HSE) department. The service system may include service personnel for performing the system maintenance (319). The service system may further include service equipment for performing the system maintenance (319). An example of a service system is described later in this disclosure.

Advantageously, the system (300) may be used to optimize the production of the one or more materials, namely, the one or more productions Pᵢ, i=1, . . . , m. For instance, in some embodiments, a first turnaround operation is performed during a first production period, according to a first deactivation schedule, denoted as S¹, that is not obtained using the system (300). As previously stated, the first deactivation schedule may be defined, for example, by one or more specialists in accordance with a deactivation strategy. The first deactivation schedule results in a first set of one or more productions, {Pᵢ(S₁), i=1, . . . , m}, of the materials during the first operation period. In embodiments not using the system (300), the first deactivation schedule is then used to perform a second turnaround operation in a second production period, resulting in similar one or more productions {Pᵢ(S¹), i=1, . . . , m} during the second production period. In contrast, using the system (300), the optimum deactivation schedule (317) is computed, denoted as S*, before the second production period begins, in an effort to optimize the production objective. Equivalently, since the production objective (307) is based on the one or more productions Pᵢ, the optimum deactivation schedule (317) is computed, before the second production period begins, in an effort to optimize the one or more productions Pᵢ. During the second production period, a second turnaround operation is performed according to the optimum deactivation schedule (317), instead of the first deactivation schedule. In other words, the first deactivation schedule is adjusted, or updated, to be equal to the optimum deactivation schedule (317) during the second production period. The optimum deactivation schedule (317) results in a second set of one or more productions, {Pᵢ(S*,), i=1, . . . , m}. Since the optimum deactivation schedule (317) is computed to optimize the one or more productions Pᵢ, the second set of one or more productions, {Pᵢ(S*,), i=1, . . . , m}, is optimized, compared to the first set of one or more productions, {Pᵢ(S¹), i=1, . . . , m}.

Advantageously, the system (300) may be adapted to any existing processing system in order to optimize the production of the one or more materials produced by the existing processing system, without the need for modifying the existing processing system. It is further noted that in some embodiments, the production functions Pᵢ, i=1, . . . , m, are updated during the life of the processing devices of the processing system. For instance, in some embodiments, the production functions Pᵢ, i=1, . . . , m, may be updated as a result of an update of one or more processing devices, an aging of one or more processing devices, or a change of a process flow of the processing system. As a result, the one or more productions {Pᵢ (S), i=1, . . . , m} of the materials may change with time independently of the deactivation schedule S, because the one or more production functions Pᵢ, change. As a result, the optimum deactivation schedule S* that optimizes the one or more production functions Pᵢ at a certain time may no longer optimize the one or more production functions Pᵢ at a later time. Advantageously, the system (300) may be used periodically to account for such changes and periodically optimize the production of the one or more materials during the life of the processing devices.

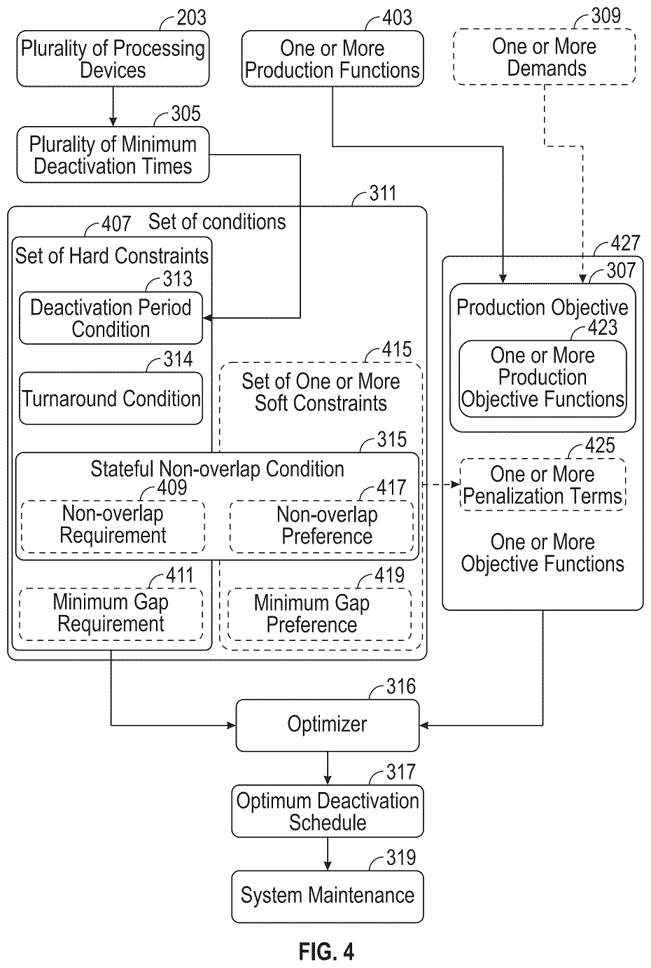

FIG. 4 depicts specific embodiments of the system (300) from FIG. 3. As a brief summary of FIG. 4, the set of conditions includes a set of hard constraints (407). The production objective (307) composes, or is part of, one or more objective functions (427). The set of conditions may further include a set of one or more soft constraints (415), each soft constraint modeled by a specific penalization term, further included as one of the one or more objective functions (427). The optimizer (316) is configured to seek to optimize the one or more objective functions (427) subject to the set of hard constraints (407).

In FIG. 4, the plurality of minimum deactivation times (305) is obtained for the plurality of processing devices (203). The plurality of minimum deactivation times (305) includes a minimum deactivation time Dᵢ for each processing device Uᵢ, for i=1, . . . , n. For each material Mᵢ among the one or more materials, a production function Pᵢ is defined by EQ. 1, resulting in one or more production functions (403). Each production function Pᵢ is configured to receive a deactivation schedule S:={Sᵢ, i=1, . . . , n} as input and return, as output, a production of the material Mᵢ, namely, Pᵢ(S). The one or more production functions (403) are used to define the production objective (307). The production objective (307) includes one or more production objective functions (423) to be minimized. The number of production objective functions in the one or more production objective functions (423) is denoted as p≥1. The one or more production objective functions (423) are denoted as Oᵢ, for i=1, . . . , p. Each production objective function Oᵢ is configured to receive a deactivation schedule S as input.

The one or more production objective functions (423) are defined such that seeking to minimize the one or more production objective functions (423) may be interpreted as seeking to fulfill the three following goals: a) maximize the production of each of the production materials if I₁≠Ø; b) minimize the production of each of the residuals materials if I₂≠Ø; c) minimize each of the mismatches γ(dᵢ, Pᵢ(S)) for i∈I₃ if I₃≠Ø. The one or more production objective functions (423) may be defined in many ways. A few examples are provided below. However, it is emphasized that the example one or more production objective functions (423) provided below are given only as examples and should be considered non-limiting. One with ordinary skill in the art will readily appreciate that the one or more production objective functions (423) may be defined in many other ways without departing from the scope of this disclosure.

As a first example of the one or more production objective functions (423), in some implementations, p=m and one specific production objective function Oᵢ is defined for each material Mᵢ, based on the production of the material Mᵢ for i=1, . . . , m. In such embodiments, if I₁≠Ø, the one or more production objective functions (423) include the opposites of the production functions:

$${O}_{i} ( S ) = - {P}_{i} ( S ) , for i ∈ {I}_{1} . \qquad EQ . 5$$

It is noted that seeking to minimize the production objective functions Oᵢ for i∈I₁ is equivalent to seeking to maximize the production Pᵢ(S) of each of the production materials. If I₂≠Ø, the one or more production objective functions (423) include the production objective functions Oᵢ, for i∈I₂:

$${O}_{i} ( S ) = {P}_{i} ( S ) , for i ∈ {I}_{2} . \qquad EQ . 6$$

If I₃≠Ø, the one or more production objective functions (423) include the mismatches from EQ. 2, for i∈I₃:

$${O}_{i} ( S ) = γ ( {d}_{i} , {P}_{i} ( S ) ) , for i ∈ {I}_{3} . \qquad EQ . 7$$

As a second example of the one or more production objective functions (423), in some implementations where I₁≠Ø, the one or more production objective functions (423) may include a single production objective function, denoted as O₁, computed as a linear combination based on the opposites of the production functions for i∈I₁:

$${O}_{1} ( S ) = - {\sum }_{i ∈ {I}_{1}} {δ}_{i}^{1} {E}_{1} ( {P}_{i} ( S ) ) . \qquad EQ . 8$$

In EQ. 8, the coefficients

$${δ}_{i}^{1} > 0$$

may be selected to specify a relative importance of each of the materials Mᵢ, for which i∈I₁. In EQ. 8, E₁ is an increasing function over the range of non-negative values satisfying E₁(0)=0, such as, for example, the identity function (E₁(x)=x) or the square function (E₁(x)=x²).

As a third example of the one or more production objective functions (423), in some implementations where I₂≠Ø, the one or more production objective functions (423) may include a single production objective function, denoted as O₁, computed as a linear combination based on the production functions for i∈I₂:

$${O}_{i} ( S ) = {\sum }_{i ∈ {I}_{2}} {δ}_{i}^{2} {E}_{2} ( {P}_{i} ( S ) ) . \qquad EQ . 9$$

In EQ. 9, the coefficients

$${δ}_{i}^{2} > 0$$

may be selected to specify a relative importance of each of the materials Mᵢ, for which i∈I₂. In EQ. 9, E₂ is an increasing function over the range of non-negative values satisfying E₂(0)=0, such as, for example, the identity function (E₂(x)=x) or the square function (E₂(x)=x²).

As a fourth example of the one or more production objective functions (423), in some implementations where I₃≠Ø, the one or more production objective functions (423) may include a single production objective function, denoted as O₃, computed as a linear combination based on the mismatches γ(dᵢ, Pᵢ(S)) from EQ. 2 for i∈I₃:

$${O}_{i} ( S ) = {\sum }_{i ∈ {I}_{3}} {δ}_{i}^{3} {E}_{3} ( γ ( {d}_{i} , {P}_{i} ( S ) ) ) . \qquad EQ . 10$$

In EQ. 10, the coefficients

$${δ}_{i}^{3} > 0$$

may be selected to specify a relative importance of each of the materials Mᵢ, for which i∈I₃. In EQ. 10, E₃ is an increasing function over the range of non-negative values satisfying E₃(0)=0, such as, for example, the identity function (E₃(x)=x) or the square function (E₃(x)=x²).

As a fifth example of the one or more production objective functions (423), in some implementations, the one or more production objective functions (423) include two or more of the objective functions from EQ. 8-10. For instance, in some implementations, the one or more production objective functions (423) are composed of three objective functions, namely, O₁, O₂ and O₃, defined by

$${O}_{1} ( S ) = - {\sum }_{i ∈ {I}_{1}} {δ}_{i}^{1} {E}_{1} ( {P}_{i} ( S ) ) , \qquad EQ . 11$$

$${O}_{2} ( S ) = {\sum }_{i ∈ {I}_{2}} {δ}_{i}^{2} {E}_{2} ( {P}_{i} ( S ) ) , \qquad EQ . 12$$

$${O}_{3} ( S ) = {\sum }_{i ∈ {I}_{3}} {δ}_{i}^{3} {E}_{3} ( γ ( {d}_{i} , {P}_{i} ( S ) ) ) . \qquad EQ . 13$$

It is noted that in some particular cases, one of the subsets I₁, I₂ and I₃ may be empty and therefore, one of EQ. 11, EQ. 12 and EQ. 13 may not be used. For instance, in some implementations, I₁∪I₂=[1, . . . , m] and O₃=Ø, meaning EQ. 13 is not used. In some implementations, I₁∪I₃=[1, . . . , m] and I₂=Ø, meaning that EQ. 12 is not used.

As a sixth example of the one or more production objective functions (423), in some implementations, the one or more production objective functions (423) include a single objective function, denoted as O₁, defined as a linear combination of EQs. 8-10:

$${J}_{4} ( S ) = - {λ}_{1} {\sum }_{i ∈ {I}_{1}} {δ}_{i}^{1} {E}_{1} ( {P}_{i} ( S ) ) + {λ}_{2} {\sum }_{i ∈ {I}_{2}} {δ}_{i}^{2} {E}_{2} ( {P}_{i} ( S ) ) + {λ}_{3} {\sum }_{i ∈ {I}_{3}} {δ}_{i}^{3} {E}_{3} ( γ ( {d}_{i} , {P}_{i} ( S ) ) ) , \qquad EQ . 14$$

where λ₁, λ₂ and λ₃ are three non-negative coefficients such that λ₁+λ₂+λ₃>0.

The set of conditions (311) includes a set of hard constraints (407) for constraining a deactivation schedule S. A deactivation schedule S is said to be feasible if it satisfies the set of hard constraints. The space of all feasible deactivation schedules is denoted as C. Thus, it is said that a deactivation schedule S belongs to C if S satisfies the set of hard constraints (407). The set of hard constraints (407) includes the deactivation period condition (313) and the turnaround condition (314), defined in the description of FIG. 3. In one or more embodiments, the set of hard constraints (407) further includes a non-overlap requirement (409). In such embodiments, the stateful non-overlap condition (315) includes the non-overlap requirement (409). Given a pre-defined first subset of two or more processing devices, denoted as U¹:={Uᵢ, i∈s₁}, where s₁ is a first subset of [1, . . . , n], a deactivation schedule S is said to satisfy the non-overlap requirement (409) if the calendared deactivation periods of pre-defined, selected pairs of distinct processing devices in U¹ do not overlap. The selected, pre-defined pairs of processing devices in U¹ are denoted as (Uᵢ_{ₖ}, Uⱼ_{ₖ}), for k∈[1, K₁] (i.e.: k=1, . . . , K₁), where K₁ is an integer defining the number of selected, pre-defined pairs of processing devices in U¹. The non-overlap requirement (409) reads:

$$\\ \begin{matrix}for all k ∈ [ 1 , {K}_{1} ] , [ {a}_{{i}_{k}} , {b}_{{i}_{k}} ] ⋂ [ {a}_{{j}_{k}} , {b}_{{j}_{k}} ] = ∅ . & EQ . 15\end{matrix}$$

The non-overlap requirement (409) aims to prevent the two processing devices of each pair (Uᵢ_{ₖ}, Uⱼ_{ₖ}) from being deactivated at the same time, for k∈[1, K₁]. In some embodiments, the processing devices from the first subset of two or more processing devices U¹ are named “essential processing devices” and deactivating two of the essential processing devices would result in the production of at least one production material being halted. In such embodiments, it may be advantageous to include every possible pair of processing devices from U¹ in the selected pairs (Uᵢ_{ₖ}, Uⱼ_{ₖ}) in order to prevent any two processing devices in U¹ from being deactivated at the same time. In such implementations, the non-overlap requirement (409) advantageously prevents the production of the at least one production material from being halted. In some implementations, s₁=[1, . . . , n], meaning that the first subset U¹ includes all the processing devices.

In one or more embodiments, the set of hard constraints (407) further includes a minimum gap requirement (411). Given a pre-defined second subset of two or more processing devices, denoted as U²:={Uᵢ, i∈s₂}, where s₂ is a second subset of [1, . . . , n], a deactivation schedule S is said to satisfy the minimum gap requirement (411) if a gap exists between calendared deactivation periods of pre-defined, selected pairs of distinct processing devices in U², and for each of the pre-defined, selected pairs, the gap is at least equal to a pre-defined minimum gap associated with the pair. The selected, pre-defined pairs of processing devices in U² are denoted as (Uᵢ_{ₖ}, Uⱼ_{ₖ}), for k∈[1, K₂], where K₂ is an integer defining the number of selected, pre-defined pairs of processing devices in U². For each pair (Uᵢ_{ₖ}, Uⱼ_{ₖ}), k∈[1, K₂], a positive minimum gap is received,

$$\\ {G}_{k}^{< 1 >} .$$

In some embodiments, the minimum gap

$$\\ {G}_{k}^{< 1 >}$$

is received, for each k∈[1, K₂], from a stakeholder of the processing system (201). Examples of stakeholders of the processing system (201) are defined earlier in this disclosure. The minimum gap requirement is written as: for all k∈[1, K₂],

$$\\ \begin{matrix}{a}_{{i}_{k}} - {b}_{{j}_{k}} \geq {G}_{k}^{< 1 >} or {a}_{{j}_{k}} - {b}_{{i}_{k}} \geq {G}_{k}^{< 1 >} . & EQ . 16\end{matrix}$$

In some implementations, the selected pairs (Uᵢ_{ₖ}, Uⱼ_{ₖ}), k∈[1, K₂], include every possible pair from the second subset U², meaning that a minimum gap is imposed between the calendared deactivation period of every two processing devices in U². In some implementations, S₂=[1, . . . , n], meaning that the second subset U² includes all the processing devices.

In one or more embodiments, the set of conditions (311) further includes a set of one or more soft constraints (415). Each soft constraint in the set of one or more soft constraints (415) includes a preference, rather than a requirement, that the deactivation schedules satisfy a property. Each soft constraint in the set of one or more soft constraints (415) is modeled by one penalization term to be optimized, rather than a restriction constraining the space of feasible deactivation schedules C. The penalization terms modeling the one or more soft constraints form one or more penalization terms (425). Each penalization term within the one or more penalization terms (425) is associated with a soft constraint within the set of one or more soft constraints (415). Determining the optimum deactivation schedule (317) subject to the set of conditions (311) further includes seeking to minimize one or more penalization terms (425).

In one or more embodiments, the set of one or more soft constraints (415) includes a non-overlap preference (417). Given a pre-defined third subset of two or more processing devices, denoted as U³:={Uᵢ, i∈s₃}, where s₃ is a third subset of [1, . . . , n], the non-overlap preference (417) is a preference that the calendared deactivation periods of pre-defined, selected pairs of distinct processing devices in U³ do not overlap. The selected, pre-defined pairs of processing devices in U³ are denoted as (Uᵢ_{ₖ}, Uⱼ_{ₖ}), for k∈[1, K₃], where K₃ is an integer defining the number of selected, pre-defined pairs of processing devices in U³. The non-overlap preference (417) seeks to prevent the two processing devices of each pair (Uᵢ_{ₖ}, Uⱼ_{ₖ}) from being deactivated at the same time, for k∈[1, K₃]. The non-overlap preference (417) is modeled by a first penalization term within the one or more penalization terms (425). In one or more embodiments, the first penalization term reads:

$$\\ \begin{matrix}{L}_{1} ( S ) = {{\sum }_{k = 1}}^{{K}_{3}} {E}_{4} ( μ ( [ {a}_{{i}_{k}} , {b}_{{i}_{k}} ] ⋂ [ {a}_{{j}_{k}} , {b}_{{j}_{k}} ] ) ) . & EQ . 17\end{matrix}$$

In EQ. 9, μ is a mathematical measure configured to evaluate the length of the interval [aᵢ_{ₖ}, bᵢ_{ₖ}]Ω[aⱼ_{ₖ}, bⱼ_{ₖ}]. In EQ. 9, E₄ is an increasing function over the range of non-negative values satisfying E₄(0)=0, such as, for example, the identity function (E₄(x)=x) or the square function (E₄(x)=x²). It is noted that in some implementations, seeking to minimize EQ. 17 may include attempting to forcefully set some of the terms E₄[aᵢ_{ₖ}, bᵢ_{ₖ}]∩[aⱼ_{ₖ}, bⱼ_{ₖ}] to 0. It is further noted that in some implementations, seeking to minimize EQ. 17 using the identity function as E₄ may result in some of the terms E₄(μ([aᵢ_{ₖ}, bᵢ_{ₖ}]∩[aⱼ_{ₖ}, bⱼ_{ₖ}]) being equal to 0, without forcefully attempting to set these terms to 0.

In one or more embodiments, the set of one or more soft constraints (415) further includes a minimum gap preference (419). Given a pre-defined fourth subset of two or more processing devices, denoted as U⁴:={Uᵢ, i∈s₄}, where s₄ is a fourth subset of [1, . . . , n], the minimum gap preference (419) is a preference that a gap exists between calendared deactivation periods of pre-defined, selected pairs of distinct processing devices in U⁴, and for each of the pre-defined, selected pairs, the gap is at least equal to a pre-defined minimum gap associated with the pair. The selected, pre-defined pairs of processing devices in U⁴ are denoted as (Uᵢ_{ₖ}, Uⱼ_{ₖ}), for k∈[1, K₄], where K₄ is an integer defining the number of selected, pre-defined pairs of processing devices in U⁴. For each pair (Uᵢ_{ₖ}, Uⱼ_{ₖ}), k∈[1, K₄], a positive minimum gap is received, denoted as

$$\\ {G}_{k}^{< 2 >} .$$

In some embodiments, the minimum gap

$$\\ {G}_{k}^{< 2 >}$$

is received, for each k∈[1, K₄], from a stakeholder of the processing system (201). Examples of stakeholders of the processing system (201) are defined earlier in this disclosure. The minimum gap preference (419) is modeled by a second penalization term within the one or more penalization terms (425). In one or more embodiments, the second penalization term reads:

$$\\ \begin{matrix}{L}_{2} ( S ) = {{\sum }_{k = 1}}^{{K}_{4}} max ( 0 , {G}_{k}^{< 2 >} - max ( {a}_{{i}_{k}} - {b}_{{j}_{k}} , {a}_{{j}_{k}} - {b}_{{i}_{k}} ) ) . & EQ . 18\end{matrix}$$

It is noted that in some embodiments, one or more of the first, second, third and fourth subsets U¹, U², U³ and U⁴ are empty, meaning that one or more of the non-overlap requirement (409), non-overlap preference (417), minimum gap requirement (411) or minimum gap preference (419) does not exist as part of the set of conditions (311). For instance, in some embodiments, the subset U¹ is empty, meaning that there is no non-overlap requirement (409) in the set of conditions (311). In other embodiments, the subsets U¹ and U² are empty, meaning that there is no non-overlap requirement (409) and no non-overlap preference (417) in the set of conditions (311). In some implementations, all of the subsets of two or more processing devices, U¹, U², U³ and U⁴ are empty, meaning that none of the non-overlap requirement (409), non-overlap preference (417), minimum gap requirement (411) or minimum gap preference (419) exist as part of the set of conditions (311). It is further noted that two processing devices cannot be subject to both the non-overlap requirement (409) and the non-overlap preference (417). Thus, the sets of pairs {(Uᵢ_{ₖ}, Uⱼ_{ₖ}) such that k∈[1, K₁]} and {(Uᵢ_{ₖ}, Uⱼ_{ₖ}) such that k∈[1, K₃]} are disjoint. Furthermore, two processing devices cannot be subject to both the minimum gap requirement (411) and the minimum gap preference (419). Thus, the sets of pairs {(Uᵢ_{ₖ}, Uⱼ_{ₖ}) such that k∈[1, K₂]} and {(Uᵢ_{ₖ}, Uⱼ_{ₖ}) such that k∈[1, K₄]} are disjoint.

The one or more objective functions (427) include the one or more production objective functions (423). The optimizer (316) is configured to seek to minimize the one or more objective functions (427) subject to the set of hard constraints (407). In embodiments of the system in FIG. 4 that include the one or more penalization terms (425), the one or more objective functions (427) further include the one or more penalization terms (425). In such embodiments, the one or more objective functions (427) includes both the one or more production objective functions (423) and the one or more penalization terms (425). The one or more objective functions (427) are denoted as Jᵢ, for i=1, . . . , q, for a certain integer q≥1. Each objective function in the one or more objective function (427) is configured to receive a deactivation schedule S as input. Two examples of the one or more objective functions (427) are defined below, by combining some of EQs. 5-13 and 17-18. However, one with ordinary skill in the art will readily appreciate that the one or more objective functions (427) may include fewer or additional components without departing from the scope of this disclosure. In particular, the one or more objective functions (427) may include different combinations of EQs. 5-13 and 17-18 without departing from the scope of this disclosure.

As a first example, the one or more objective functions (427) may be composed of three objective functions: a linear combination of the mismatches from EQ. 10, the non-overlap preference from EQ. 17 and the minimum gap preference from EQ. 18, using, in EQ. 10, y as the absolute value of the difference, E₃ as the square function,

$$\\ {δ}_{i}^{3} = 1$$

for i∈I₃ and using, in EQ. 17, E₄ as the identity function:

$$\\ \begin{matrix}\{ \begin{matrix}{J}_{1} ( S ) = {\sum }_{i ∈ {I}_{3}} {( {P}_{i} ( S ) - {d}_{i} )}^{2} , \\ {J}_{2} ( S ) = {\sum }_{k = 1} {E}_{4} ( μ ( [ {a}_{{i}_{k}} , {b}_{{i}_{k}} ] ⋂ [ {a}_{{j}_{k}} , {b}_{{j}_{k}} ] ) ) , \\ {J}_{3} ( S ) = {\sum }_{k = 1} max ( 0 , {G}_{k}^{< 2 >} - max ( {a}_{{i}_{k}} - {b}_{{j}_{k}} , {a}_{{j}_{k}} - {b}_{{i}_{k}} ) ) .\end{matrix} & EQ . 19\end{matrix}$$

Minimizing EQ. 19 may be seen as minimizing the mismatch between production and demand of the materials Mᵢ such that i∈I₃ while minimizing the overlap between the calendared deactivation periods associated with processing devices of pairs in U³ and seeking to enforce a minimum gap between the calendared deactivation periods associated with processing devices of pairs in U⁴.

As a second example, the one or more objective functions (427) may include two objective functions: a linear combination of the opposites of the production objective functions from EQ. 8 and the non-overlap preference from EQ. 17, using, in EQ. 8,

$${δ}_{i}^{1} = 1$$

for i∈I₁ and E₁ as the identity function and using, in EQ. 17, E₄ as the identity function:

$$\\ \begin{matrix}\{ \begin{matrix}{J}_{1} ( S ) = - {\sum }_{i ∈ {I}_{1}} {P}_{i} ( S ) , \\ {J}_{2} ( S ) = {{\sum }^{{K}_{3}}}_{k = 1} {E}_{4} ( μ ( [ {a}_{{i}_{k}} , {b}_{{i}_{k}} ] ⋂ [ {a}_{{j}_{k}} , {b}_{{j}_{k}} ] ) ) .\end{matrix} & EQ . 20\end{matrix}$$

Minimizing EQ. 20 may be seen as maximizing the production of the materials Mᵢ such that i∈I₁ while minimizing the overlap between the calendared deactivation periods associated with processing devices of pairs in U³.

The one or more objective functions (427) are optimized subject to the set of hard constraints (407) according to the following optimization problem:

$$\\ \begin{matrix}minimize \{ {J}_{i} ( S ) , i ∈ [ 1 , q ] \} subject to S ∈ C . & EQ . 21\end{matrix}$$

In one or more embodiments, such as the ones presented in EQs. 19 and 20, the number of objective functions, q, is greater than 1, meaning that the one or more objective functions (427) include a plurality of objective functions. In such embodiments, EQ. 21 is a muti-objective optimization problem:

$$\\ \begin{matrix}minimize \{ {J}_{1} ( S ) , … , {J}_{q} ( S ) \} subject to S ∈ C . & EQ . 22\end{matrix}$$

However, embodiments in which q=1 are not excluded from this disclosure, in which case EQ. 21 is a single-objective optimization problem:

$$\\ \begin{matrix}minimize {J}_{1} ( S ) subject to S ∈ C . & EQ . 23\end{matrix}$$

Examples of the optimizer (316) for solving the single optimization problem in EQ. 23 include, for example, a simplex method, an interior point method, a Lagrange multipliers method, a branch and bound method, a linear programming algorithm, a genetic algorithm and a generalized reduced gradient (GRG) method.

In scenarios where q>1, the optimizer (316) may be defined in many ways. Three different configurations are defined below: a multi-objective configuration, a single-objective configuration, and a sequential, multi-stage configuration. However, one with ordinary skill in the art will readily appreciate that the optimizer (316) may be configured in many other ways known in the art of multi-objective optimization without departing from the scope of this disclosure.

In one or more embodiments, the optimizer (316) is a multi-objective optimizer configured to seek to minimize the objective functions {J₁(S), . . . , J_{q}(S)} simultaneously in EQ. 22. In such embodiments, a partial order relation is defined, denoted as “≤”. Given two deactivation schedules S¹ and S², the partial order relation “≤” is configured to attempt to compare the two objective vectors (J₁(S¹), . . . , J_{q}(S¹))) and (J₂(S²), . . . , J_{q}(S²))). Examples of such a partial order relation include a Pareto order. As a reminder, a vector \vec{u}={uᵢ, i∈[1, q]} is said to Pareto dominate a vector \vec{v}={vᵢ, i∈[1, q]} if the two following conditions are satisfied:

$$\\ \begin{matrix}\{ \begin{matrix}there exists {i}_{1} ∈ [ 1 , q ] such that {u}_{{i}_{1}} > {v}_{{i}_{1}} , and \\ for all {i}_{2} ∈ [ 1 , q ] with {i}_{2} \neq {i}_{1} , {u}_{{i}_{2}} \geq {v}_{{i}_{2}} .\end{matrix} & EQ . 24\end{matrix}$$

If EQ. 24 is satisfied, it is written that \vec{u}>\vec{v} or \vec{v}<\vec{u}. By extension, the vector \vec{u}={uᵢ, i∈[1, q]} is said to equate or Pareto dominate a vector \vec{v}={vᵢ, i∈[1,q]} if \vec{u}>\vec{v} or \vec{u}=\vec{v}, in which case it is written that \vec{u}≥\vec{v} or \vec{v}≤\vec{u}. In scenarios where there exists i₁∈[1, q] such that uᵢ_{₁}>vᵢ_{₁} and i₂∈[1, q] such that uᵢ_{₂}<vᵢ_{₂} the vectors \vec{u} and \vec{v} are not comparable under the Pareto order. Thus, for some pairs of two deactivation schedules S¹ and S², the objective vectors (J₁ (S₁), . . . , J_{q}(S₁))) and (J₂ (S₂), . . . , J_{q}(S₂))) might be comparable under the Pareto order. Using the partial order relation “≤”, the multi-objective optimization problem from EQ. 22 interpreted as:

$$\\ \begin{matrix}find {S}^{★} ∈ C such that for all S ∈ C , J ( {S}^{★} ) ≼ J ( S ) , & EQ . 25\end{matrix}$$

using the vectorized notations J(S):=(J₁ (S), . . . , J_{q}(S)) and J(S*):=(J₁ (S*), . . . , J_{q}(S*)). As a multi-objective optimizer, the optimizer (316) may be configured in many ways known in the art of multi-objective constrained optimization. In some implementations, the optimizer (316) includes a genetic algorithm, such as a multi-objective evolutionary algorithm, such as, for example, non-dominated Sorting Genetic Algorithms II and III and Strength Pareto Evolutionary Algorithm 2. In other implementations, the optimizer (316) includes a modified normal boundary intersection algorithm, successive Pareto optimization or a directed search domain method.

In other embodiments, the optimizer (316) is configured to interpret EQ. 22 as a single-objective optimization problem and seek to solve the single-optimization problem using a single-objective optimization algorithm. In such embodiments, the optimizer (316) includes a scalarization of the one or more objective functions (427) into a single, combined objective function, denoted as J^{c}. Examples of a scalarization include a weighted summation, in which the one or more objective functions (427) are combined as:

$$\\ \begin{matrix}{J}^{c} ( S ) = {{\sum }^{q}}_{i = 1} {θ}_{i} {J}_{i} ( S ) , & EQ . 26\end{matrix}$$

where the coefficients θᵢ>0 are positive real numbers for i=1, . . . , q, that may be tuned to give a specific relative importance to each objective function Jᵢ in the one or more objective functions (427). The multi-objective optimization problem from EQ. 22 is then interpreted as the following single objective optimization problem:

$$\\ \begin{matrix}find {S}^{★} ∈ C such that for all S ∈ C , {J}^{c} ( {S}^{★} ) \leq {J}^{c} ( S ) . & EQ . 27\end{matrix}$$

The optimizer (316) includes a single-objective optimization algorithm for solving EQ. 27. The single-optimization algorithm may be defined in many ways used in the art of single-objective constrained optimization, such as, for example, a simplex method, an interior point method, a Lagrange multipliers method, a branch and bound method, a linear programming algorithm, a genetic algorithm and a generalized reduced gradient (GRG) method.

In other embodiments, the optimizer (316) is configured as a sequential optimizer including multiple stages, run sequentially. Examples of a sequential optimizer include a multi-stage lexicographic method. In one or more embodiments, the optimizer (316) is configured to seek to solve, sequentially, each of the following single-objective optimization problems, for i=1, . . . , q:

$$\\ \begin{matrix}find {S}^{★ , i} ∈ {C}^{i} such that for all S ∈ {C}^{i} , {J}_{i} ( {S}^{★ , i} ) \leq {J}_{i} ( S ) , & EQ . 28\end{matrix}$$

where, for all i=1, . . . , q, Cⁱ is a recurrent constraint set defined below. At each stage, the optimizer (316) seeks to solve EQ. 28 for a specific i=1, . . . , q, starting from i=1. The optimum deactivation schedule (317) is selected as an output \vec{S}^{q} of the last stage. Generally, it is not assumed that the optimizer (316) finds S*,ᵢ that satisfies Jᵢ(S*,ⁱ)≤Jᵢ(S) for all S at each stage. Instead, by seeking solves EQ. 28, the optimizer (316) computes a solution Ŝⁱ approximating S*,ⁱ. The recurrent constraint set Cⁱ is defined by:

$$\\ \begin{matrix}\{ \begin{matrix}{C}^{1} = C , \\ {C}^{i} = \{ S ∈ C such that for all k < i , {J}_{k} ( S ) \leq {J}_{k} ( \hat{S} {}^{k} ) \} for i > 1\end{matrix} . & EQ . 29\end{matrix}$$

In such implementations, the optimizer (316) includes a single-objective optimization algorithm for solving EQ. 28 at each stage. The single-optimization algorithm may be defined in many ways and include, for example, a simplex method, an interior point method, a Lagrange multipliers method, a branch and bound method, a linear programming algorithm, a genetic algorithm and a generalized reduced gradient (GRG) method.

For each stage i>1, the solution Ŝⁱ accounts for the optimization realized in the previous stage(s) according to the recurrent constraint sets C^{j}, j<i. In other words, the constraint set Cⁱ ensures that no deactivation schedules conflicting with previously resolved constraints (i.e.: no deactivation schedules falling outside of any constraint set C^{j}, j<i) are introduced. Thus, in some embodiments, the optimizer (316) configured as in EQs. 28-29 may be interpreted as an attempt to gradually build the optimum deactivation schedule (317) by restricting the constraints incrementally. The optimizer (316) as defined in EQs. 28-29 may be referred to as a “stateful optimizer”.

It is noted that, advantageously, the system in FIG. 4 is adaptive. The set of hard constraints (407) and set of one or more soft constraints (415) may be adjusted or adapted to a specific processing system to which the system in FIG. 4 is applied. In particular, each of the non-overlap requirement (409), non-overlap preference (417), minimum gap requirement (411) or minimum gap preference (419) may be selected or discarded, depending on the specific processing system to which the system in FIG. 4 is applied. Furthermore, the set of hard constraints (407) and set of one or more soft constraints (415) may include additional components, not disclosed herein, without departing from the scope of this disclosure.

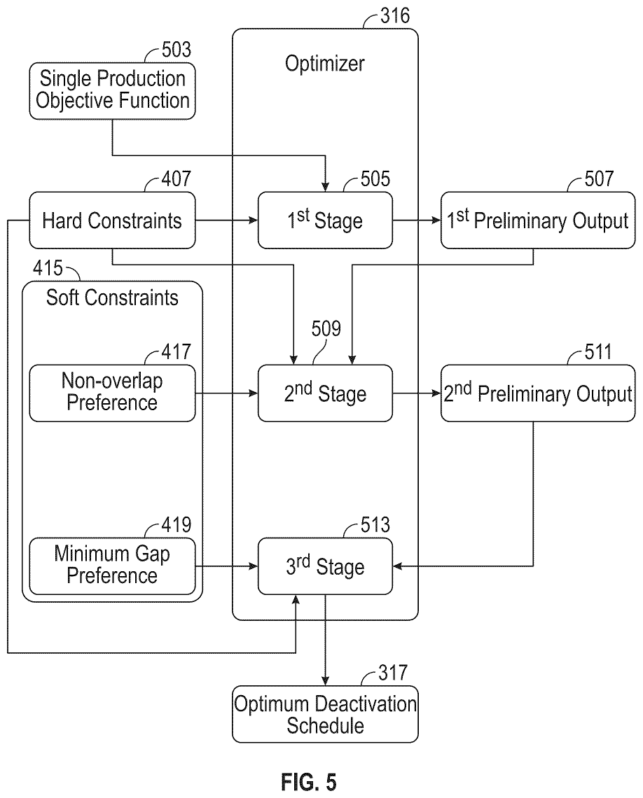

FIG. 5 depicts a specific implementation of the optimizer (316) configured as a multi-stage non-linear optimization algorithm. In FIG. 5, the processing system is assumed to include n≥3 processing devices Uᵢ, i=1, . . . , n, producing m≥2 materials Mᵢ, for i=1, . . . , m. The processing system receives a demand, dᵢ, for each material Mᵢ, for i=1, . . . , m. The production objective (307) includes a single production objective function (503), denoted as J₁, based on the mismatches between the production and demand of each of the materials Mᵢ, for i=1, . . . , m. The single production objective function (503) is selected from EQ. 10, with 13=[1, . . . , m], E₃ as the square function

$${δ}_{i}^{3} = 1$$

for i=1, . . . , m. The production period is set to ninety days. The maximum turnaround time to perform the turnaround operation is set to Tₘₐₓ=80 days. For each i=1, . . . , n, a minimum deactivation time, Dᵢ, is received associated with the processing device Uᵢ. There is a non-overlap requirement, included in the set of hard constraints (407), that the calendared deactivation periods of the first two processing devices, U₁ and U₂, do not overlap. Two soft constraints compose the set of one or more soft constraints (415). A first soft constraint is a non-overlap preference (417) that none of the calendared deactivation periods of the processing devices Uᵢ overlap, for i≥2. The first soft constraint is modeled by EQ. 17 with E₄ as the square function. The third subset is defined as U³:={Uᵢ, i≥2} and the pairs of processing devices subject to the non-overlap preferences are the pairs (Uᵢ, Uⱼ) such that i≥2, j≥2 and i+j. A second soft constraint is a minimum gap preference (419) that the calendared deactivation periods associated the first two processing devices, U₁ and U₂, be at least 5 days. Thus, the second soft constraint concerns only one pair of processing devices, namely, (U₁, U₂), with an associated minimum gap of

$$\\ {G}_{1}^{< 2 >} = 5.$$

The second soft constraint is modeled by EQ. 18 with

$$\\ {G}_{1}^{< 2 >} = 5.$$

Accordingly, the one or more objective functions (427) include three objective functions, namely, one production objective function and two penalizations terms, each penalizations term associated with one of the two soft constraints:

$$\\ \begin{matrix}\{ \begin{matrix}{J}_{1} ( S ) = {{\sum }_{i = 1}}^{m} {( {P}_{i} ( S ) - {d}_{i} )}^{2} , \\ {J}_{2} ( S ) = {{\sum }_{i = 2}}^{n} {{\sum }_{\begin{matrix}j = 2 \\ j \neq i\end{matrix}}}^{n} {( μ ( [ {a}_{i} , {b}_{i} ] ⋂ [ {a}_{j} , {b}_{j} ] ) )}^{2} , \\ {J}_{3} ( S ) = max ( 0 , 5 - max ( {a}_{1} - {b}_{2} , {a}_{2} - {b}_{1} ) ) .\end{matrix} & EQ . 30\end{matrix}$$

The set of hard constraints includes three hard constraints, namely,

$$\\ \begin{matrix}\{ \begin{matrix}{C}_{1} : {b}_{i} - {a}_{i} \geq {D}_{i} , i = 1 , … , n , ( deactivation period condition ) , \\ {C}_{2} : {max}_{i = 1 , … , n} {b}_{i} - {min}_{i = 1 , … , n} {a}_{i} \leq 80 ( turnaround condition ) , \\ {C}_{3} : [ {a}_{1} , {b}_{1} ] ⋂ [ {a}_{2} , {b}_{2} ] = ∅ ( non - overlap requirement ) .\end{matrix} & EQ . 31\end{matrix}$$

The space of feasible deactivation schedules, C, is defined as the set of all deactivation schedules S:={[aᵢ, bᵢ], i=1, . . . , n} satisfying the hard constraints C₁, C₂ and C₃ from EQ. 31.

Following EQ. 22, the optimization problem to be solved in FIG. 5 is:

$$\\ \begin{matrix}minimize \{ {J}_{1} ( S ) , {J}_{2} ( S ) , {J}_{3} ( S ) \} subject to S ∈ C . & EQ . 32\end{matrix}$$

To solve the optimization problem in EQ. 32, a lexicographic method is used in which the optimizer (316) includes three stages. In each stage, the optimizer (316) seeks to minimize one of the objective functions J₁, J₂ and J₃. In a first stage (505), the optimizer (316) is configured to seek to solve the following minimization problem:

$$\\ \begin{matrix}find {S}^{★ , 1} ∈ C such that for all S ∈ C , {J}_{1} ( {S}^{★ , 1} ) \leq {J}_{1} ( S ) . & EQ . 33\end{matrix}$$

In the first stage (505), the optimizer (316) returns, as output, a first preliminary output (507), denoted as Ŝ¹, that may be interpreted as an approximation of S*,¹. In a second stage (509), the optimizer (316) is configured to seeks to solve the following minimization problem:

$$\\ \begin{matrix}find {S}^{★ , 2} ∈ {C}^{2} such that for all S ∈ {C}^{2} , {J}_{2} ( {S}^{★ , 2} ) \leq {J}_{1} ( S ) , & EQ . 34\end{matrix}$$

where C²={S∈C such that J₁(S)≤J₁ (Ŝ¹)}. In the second stage (509), the optimizer (316) returns, as output, a second preliminary output (511), denoted as Ŝ², that may be interpreted as an approximation of S*,². In a third stage (513), the optimizer (316) is configured to seek to solve the following minimization problem:

$$\\ \begin{matrix}find {S}^{★ , 3} ∈ {C}^{3} such that for all S ∈ {C}^{3} , {J}_{3} ( {S}^{★ , 3} ) \leq {J}_{3} ( S ) , & EQ . 35\end{matrix}$$

where C³={S∈C such that J₁(S)≤J₁ (Ŝ¹) and J₂(Ŝ¹)≤J₂ (Ŝ²)}. In the third stage (513), the output of the optimizer (316), denoted as Ŝ³, may be interpreted as an approximation of S*,³. In the third stage (513), the output Ŝ³ is selected as the optimum deactivation schedule (317).

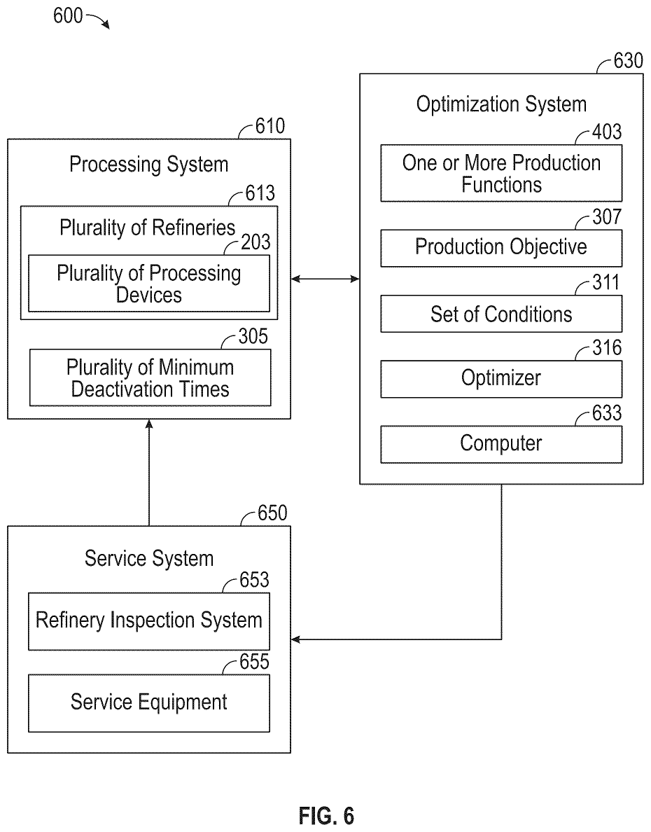

It is noted that since the first stage (505), second stage (509) and third stage (513) sequentially seek to solve a specific objective function in accordance with the output(s) of the previous stage(s), the optimum deactivation schedule (317) may depend on the order in which the first stage (505), second stage (509) and third stage (513) are run. In the specific embodiment presented in FIG. 5, the third stage (513) is run after the second stage (509), that is run after the first stage (505). In other embodiments not presented herein, the first stage (505), second stage (509) and third stage (513) may be run in a different order without departing from the scope of this disclosure. Running the first stage (505), second stage (509) and third stage (513) in different order from the one presented in FIG. 6 may result in a different optimum deactivation schedule (317).

As mentioned earlier in this disclosure, the outputs of the second and third stage (i.e.: the second preliminary output (511) and the optimum deactivation schedule (317)) account for the optimization realized in the previous stage(s). In the second stage (509), the constraint set C² ensures that no deactivation schedules conflicting with the previous constraint set C¹ (i.e.: no deactivation schedules falling outside of C¹) are introduced. In the third stage (513), the constraint set C³ ensures that no deactivation schedules conflicting with the previous constraint sets C¹ and C² (i.e.: no deactivation schedules falling outside of C¹ or C²) are introduced. Thus, in some embodiments, the implementation of the optimizer (316) in FIG. 5 may be interpreted as an attempt to gradually build the optimum deactivation schedule (317) by restricting the constraints incrementally. The implementation of the optimizer (316) in FIG. 5 may be referred to as a “stateful optimizer”.

FIG. 6 depicts a block diagram of a system (600) for performing maintenance of a processing system (610) in accordance with an optimum deactivation schedule computed using the system (300). The system (600) includes the processing system (610), an optimization system (630) and a service system (650). The processing system (610) includes a plurality of refineries (613) that includes the plurality of processing devices (203), denoted as Uᵢ, for i=1, . . . , n. The processing system (610) is configured to produce the one or more materials, denoted as Mᵢ, for i=1, . . . , m. Each processing device Uᵢ is configured to be deactivated during calendared deactivation period, Sᵢ=[aᵢ, bᵢ], associated with the processing device Uᵢ, for i=1, . . . , n. The calendared deactivation periods of the processing devices in the plurality of processing devices (203) form a deactivation schedule S:={Sᵢ, i=1, . . . , n}. The processing system (610) is configured to receive the plurality of minimum deactivation times (305) including, for each calendared deactivation period Sᵢ, a minimum deactivation time Dᵢ, for i=1, . . . , n.

The optimization system (630) includes the one or more production functions (403), denoted as Pᵢ, for i=1, . . . , m, configured to receive S as input. For i=1, . . . , m, the production of the material Mᵢ during the turnaround period is denoted as Pᵢ(S). The one or more production functions (403) are used to define the production objective (307). The production objective (307) includes one or more production objective functions (423) to be minimized. Example of the one or more objective functions (427) include, for example, the production objective functions in EQs. 5-14. The optimization system (630) further includes the set of conditions (311). The set of conditions (311) includes a set of hard constraints (407). The set of hard constraints (407) includes the deactivation period condition (313) and the turnaround condition (314) as defined in the description of FIG. 3. The set of hard constraints (407) may further include other hard constraints such as, for example, the non-overlap requirement (409), the minimum gap requirement (411), or both.

In one or more embodiments, the set of conditions (311) further includes a set of one or more soft constraints (415). The set of one or more soft constraints (415) may include, for example, the non-overlap preference (417), the minimum gap preference (419), or both. The non-overlap preference (417) and the minimum gap preference (419) are defined, for example, by EQs. 17 and 18. Each soft constraint in the set of one or more soft constraints (415) is modeled by a penalization term. The one or more soft constraints in the set of one or more soft constraints (415) define the one or more penalization terms (425) in FIG. 4. The one or more penalization terms (425) are included in the one or more objective functions (427) to be minimized. The production objective (307) and the set of hard constraints (407) are used to define the optimization problem in EQ. 21. The optimization system (630) further includes the optimizer (316), configured to seek to solve the optimization problem in EQ. 21.

In some implementations, the optimization problem in EQ. 21 is a single-objective optimization problem such as the one defined in EQ. 23. In other implementations, the optimization problem in EQ. 21 is a multi-objective optimization problem such as the one defined in EQ. 22. In such implementations, the optimizer may be configured in many ways, three of which are presented in this disclosure. In some implementations, the optimizer (316) includes a multi-objective optimization algorithm allowing to solve the optimization problem EQ. 21 as interpreted in EQ. 25. In other implementations, the optimizer (316) includes scalarizing the one or more objective functions (427) into a single objective function such as the objective function J^{c} in EQ. 26. In such implementations, the optimizer (316) is configured to seek to solve the optimization problem EQ. 21 as interpreted in the single-objective in EQ. 27. In such implementations, the optimizer (316) may include any algorithm that allows for solving a constrained single-objective optimization problem. In further implementations, the optimizer (316) is configured as a sequential optimizer that includes seeking to solve, sequentially, the family of single-objective optimization problems defined by EQ. 28. A specific example of a sequential optimizer is depicted in FIG. 5. The optimization system (630) further includes a computer (633), in which the optimizer (316) is hosted and run.

The service system (650) is configured to perform a system maintenance (319) of the processing system (610) in accordance with the optimum deactivation schedule (317). The service system (650) may include one or more departments, such as an engineering department, a human resource department, a construction department, a maintenance department, a mechanical department, a legal department, a sales department, a research and development department and a Health, Safety and Environment (HSE) department. The system maintenance (319) includes a maintenance activity for each processing device while the processing device is deactivated, during the optimum calendared deactivation period associated with the processing device. For each processing device, the maintenance activity may be of many types. Moreover, the maintenance activity may be of a different type for two different processing devices. In one or more embodiments, the maintenance activity performed on a processing device includes an inspection of the processing device.

The inspection is performed by a refinery inspection system (653). The refinery inspection system (653) may be structured in many ways and include various components. The refinery inspection system (653) may include service personnel for performing the system maintenance (319). Service personnel may include various service workers. Examples of service workers that may be part of the service personnel include one or more analysts, engineers, technicians, construction workers and maintenance workers who plan and perform the facility operation. The service system (650) further includes service equipment (655) that may be used by the refinery inspection system (653) for performing the system maintenance (319). In some embodiments, the refinery inspection system (653) includes the service equipment (655). The service equipment (655) may include various components. Examples of components of the service equipment (655) may include construction materials, such as cement, sand, water and metal. Examples of components of the service equipment (655) may further include tools, such as a hammer, a drill, a wrench, a clamp and a chisel.

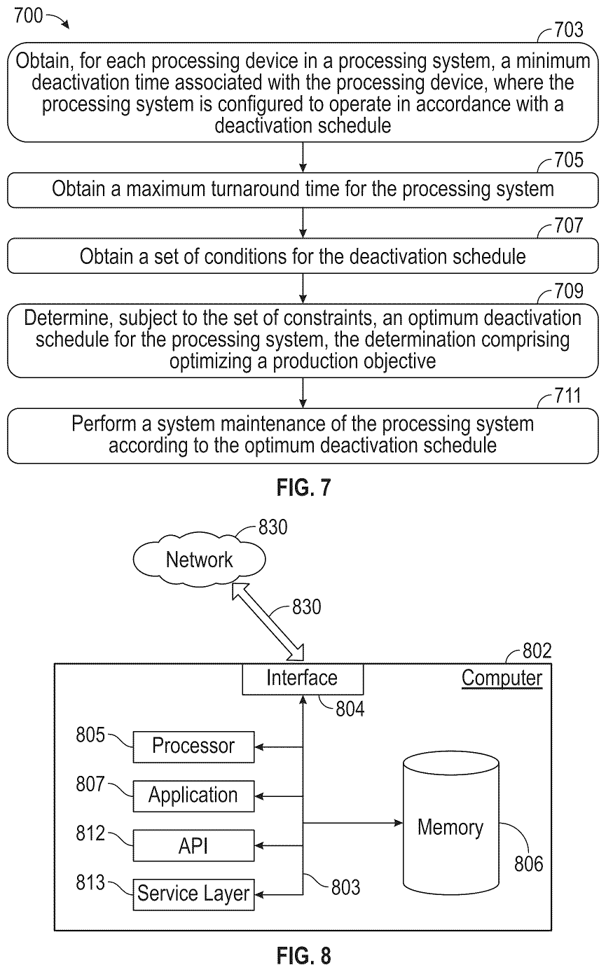

FIG. 7 depicts a flow chart of a method (700) for determining an optimum deactivation schedule for a processing system. For brevity, a full description of components and/or elements depicted in FIG. 7 is not provided anew for those components and/or elements that have been previously described with reference to the preceding figures. The processing system is configured to produce one or more materials, denoted as Mᵢ, for i=1, . . . , m, where m≥1 is the number of materials in the one or more materials. The one or more materials include production materials. Production materials are defined as materials produced for a benefit, such as materials to be used as an energy source, construction materials, materials sold for a revenue, or any combination thereof. In some embodiments, the one or more materials further include one or more waste materials. Waste materials are defined as by-products of processes for producing the production materials. The processing system may be defined in many ways in a similar fashion to the processing system (201) in FIG. 2 or the processing system (610) in FIG. 6. As such, the processing system may include an oil refinery, a gas processing plant, a chemical plant. In some embodiments, the processing system includes any combination of one or more oil refineries, one or more gas processing plants and one or more chemical plants. The processing system (201) includes a plurality of processing devices, such as the plurality of processing devices (203) in FIG. 2. The processing devices in the plurality of processing devices are denoted as Uᵢ, for i=1, . . . , n, for a certain n>1.

A production period is a predefined interval of time during which the processing system is operated. The production period may be defined for example, as a specific month of the year, a specific quarter, a specific year or specific decade. During a production period, a turnaround operation occurs, during which a set of processing devices, where each processing device in the set is denoted as Ut, is deactivated at a certain calendared deactivation period, denoted as Sᵢ, associated with the processing device Uᵢ, for i=1, . . . , n. The calendared deactivation periods of the processing devices form a plurality of calendared deactivation periods, similar to the plurality of calendared deactivation periods (205) in FIG. 2. Each calendared deactivation period Sᵢ includes a time interval, [aᵢ, bᵢ], during which the processing device Uᵢ is deactivated, for i=1, . . . , n. For each time intervals, [aᵢ, bᵢ], at is called a start time of the calendared deactivation period and bᵢ is called an end time of the calendared deactivation period, with bᵢ>aᵢ, for i=1, . . . , n. For each processing device Uᵢ, a deactivation time Tᵢ is defined as the duration of the calendared deactivation period Sᵢ, so that Tᵢ:=bᵢ−aᵢ, for i=1, . . . , n. The plurality of calendared deactivation periods (205) of the processing devices in the plurality of processing devices (203) form a deactivation schedule (207) of the processing system (201), the deactivation schedule (207) denoted as S:={Sᵢ, i=1, . . . , n}. A duration of the turnaround operation is defined as total duration of the deactivation schedule (207), namely,

$$\\ T := {max}_{i = 1 , … , n} {b}_{i} - {min}_{i = 1 , … , n} {a}_{i} .$$

If a processing device is involved in the production of a given material, deactivating the processing device may affect the production of the given material. Generally, the production of each of the one or more materials Mᵢ, during the production period, may be expressed as a function of the deactivation schedule. In that regard, EQ. 1 connects, via the production function Pᵢ, the deactivation schedule to a production of the material Mᵢ, denoted as Pᵢ(S), for i=1, . . . , m.

Generally, a maintenance activity requires a certain amount of time to be performed on a processing device. Thus, any processing device requires to be deactivated long enough for the maintenance activity to be performed. In that regard, in Step 703, a minimum deactivation time, Dᵢ, is received for each processing device Uᵢ, for i=1, . . . , n. The minimum deactivation times Dᵢ, for i=1, . . . , n, form a plurality of minimum deactivation times, similar to the plurality of minimum deactivation times (305) in FIG. 3. In one or more embodiments, each minimum deactivation time Dᵢ is an expected amount of time taken to perform a maintenance activity for the processing device Uᵢ, for i=1, . . . , n. In Step 705, a maximum turnaround time is obtained. The maximum turnaround time is defined as a maximum amount of time allocated for the turnaround operation.

In Step 707, a set of conditions is obtained for the deactivation schedule. The set of conditions in Step 707 is defined in a similar fashion to the set of conditions (311) in FIG. 3. The set of conditions includes a deactivation period condition and a turnaround condition. The deactivation period condition is defined in the same way as the deactivation period condition (313) in FIG. 3: bᵢ−aᵢ≥Dᵢ, for i=1, . . . , n. In other words, the deactivation period condition is a requirement that a deactivation time Tᵢ of each processing device Uᵢ, defined as Tᵢ:=bᵢ−aᵢ, be at least equal to the minimum deactivation times Dᵢ. The turnaround condition is a requirement that the total duration of the deactivation schedule, defined as T=bₗₐₛₜ−a_{first}, where bₗₐₛₜ is the end time of the calendared deactivation period for the last processing device in the deactivation schedule (or the processing device with the latest calendared deactivation period) and a_{first} is the start time of the calendared deactivation period for the first processing device in the deactivation schedule (or the processing device with the first calendared deactivation period). The set of conditions includes a stateful non-overlap condition, similar to the stateful non-overlap condition (315) in FIG. 3. The stateful non-overlap condition (315) includes seeking to reduce the overlap of the calendared deactivation periods of pairs of processing devices within a pre-defined subset of the processing devices Uᵢ.

The set of conditions includes a set of hard constraints, that includes the deactivation period condition and the turnaround condition. In one or more embodiments, the set of hard constraints further includes a non-overlap requirement, that is part of the stateful non-overlap condition. The non-overlap requirement is a constraint that calendared deactivation periods of pre-defined, selected pairs of distinct processing devices in a first subset of processing devices U¹ do not overlap. The non-overlap requirement is written in EQ. 15. In one or more embodiments, the set of hard constraints further includes a minimum gap requirement. The minimum gap requirement is a constraint that a gap exists between calendared deactivation periods of pre-defined, selected pairs of distinct processing devices in a second subset of processing devices U², and that, for each of the pre-defined, selected pairs, the gap is at least equal to a pre-defined minimum gap associated with the pair. In such embodiments, the method (700) further includes obtaining, for each of these pairs, the minimum gap associated with the pair. In some implementations, the minimum gap requirement is given by EQ. 16.

In some implementations, the set of conditions further includes a set of one or more soft constraints, similar to the set of one or more soft constraints (415) in FIG. 4. Each soft constraint in the set of one or more soft constraints is modeled by one penalization term to be minimized. The penalization terms modeling the one or more soft constraints form one or more penalization terms. In one or more embodiments, the set of one or more soft constraints includes a non-overlap preference, similar to the non-overlap preference (417) in FIG. 4. The non-overlap preference is a preference that that the calendared deactivation periods of pre-defined, selected pairs of distinct processing devices in a third subset of processing devices U³ do not overlap. In some implementations, the non-overlap preference is modeled by the first penalization term in EQ. 17. In one or more embodiments, the set of one or more soft constraints include a minimum gap preference, similar to the minimum gap preference (419) in FIG. 4. The minimum gap preference is a preference that a gap exists between calendared deactivation periods of pre-defined, selected pairs of distinct processing devices in a fourth subset of processing devices U⁴, and that, for each of the pre-defined, selected pairs, the gap is at least equal to a pre-defined minimum gap associated with the pair. In such embodiments, the method (700) further includes, for each of these pairs, obtaining the minimum gap associated with the pair. In some implementations, the minimum gap preference is modeled by the second penalization term in EQ. 18.

In Step 709, an optimum deactivation schedule is determined, subject to the set of constraints from Step 707, for the processing system. The optimum deactivation schedule in Step 709 is determined in a similar fashion to the optimum deactivation schedule (317) in FIGS. 3-5. The optimum deactivation schedule includes, for each processing device Uᵢ, a calendared deactivation period associated with the processing device Uᵢ, called an optimum calendared deactivation period associated with the processing device Uᵢ. Determining the optimum deactivation schedule includes optimizing a production objective based on the production of each material Mᵢ, for i=1, . . . , m. The production objective is defined in a similar fashion to the production objective (307) in FIG. 3. In one or more embodiments, such as the ones presented in FIG. 4, the production objective in Step 709 includes certain number p≥1 of production objective functions, Oᵢ, i=1, . . . , p, each depending on the deactivation schedule. In some implementations, optimizing the production objective includes minimizing the production objective functions over the deactivation schedule. Examples of production objective functions to be minimized in order to optimize the production objective are given by EQs. 5-14.

In some implementations, one or more objective functions are defined in Step 709 in a similar fashion to the one or more objective functions (427) in FIG. 4. The one or more objective functions are denoted as Jᵢ, for i=1, . . . , q, for a certain integer q≥1. The one or more objective functions include the one or more production objective functions. In embodiments of the method (700) where the set of conditions include a set of one or more soft constraints, the one or more objective functions further include the one or more penalization terms derived from the one or more soft constraints. In one or more embodiments, the optimum deactivation schedule is computed by running an optimizer configured to minimize the one or more objective functions subject to the set of hard constraints, as written in EQ. 21. The optimizer may be defined in many ways. If q>1, the optimizer may include a multi-objective optimizer that interprets EQ. 21 as EQ. 25, in accordance with one or more embodiments. In other embodiments, the optimizer is configured to scalarize the one or more objective functions into the single objective function in EQ. 26 and seek to solve the single objective optimization problem in EQ. 27. In further embodiments, the optimizer includes a sequential optimizer configured to seek to solve, sequentially, the single objective, recurrent optimization problem from EQs. 28 and 29. A specific example of a sequential optimizer is depicted in FIG. 5.

In Step 711, a system maintenance of the processing system is performed in accordance with the optimum deactivation schedule from Step 707. The system maintenance includes performing, for each processing device Uᵢ, one or more maintenance activities during the optimum calendared deactivation period associated with the processing device, while the processing device is deactivated. Maintenance activities may be of several types and include, for example, an inspection of the processing device, a cleaning of the processing device, a tuning of the processing device and a repair of the processing device, such as, for example, replacing a part of the processing device. In one or more embodiments, the system maintenance is performed by a service system, such as the service system (650) in FIG. 6.

As previously described, the method (700) may be used advantageously to optimize the production of the one or more materials. In some embodiments, a first turnaround operation is performed during a first production period, according to a first deactivation schedule, that is not obtained using the method (700). The first deactivation schedule may be defined, for example, by one or more specialists in accordance with a deactivation strategy. The first deactivation schedule results in a first set of one or more productions in the first operation period. Using the method (700), the optimum deactivation schedule is computed, before the second production period begins, to optimize the productions of the one or more materials. During the second production period, a second turnaround operation is performed according to the optimum deactivation schedule (317), instead of the first deactivation schedule. The optimum deactivation schedule results in a second set of one or more productions that is optimized, compared to the first set of one or more productions.

As stated, the computations mentioned in this disclosure may be performed by a computer, such as the computer (633) in FIG. 6. In that regard, FIG. 8 depicts a block diagram of a computer (802) used to provide computational functionalities associated with described algorithms, methods, functions, processes, flows, and procedures as described in this disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environments (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium. For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers such as the computer (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers such as the computer (802).

The following examples are merely illustrative and should not be interpreted as limiting the scope of the present disclosure.

### Examples

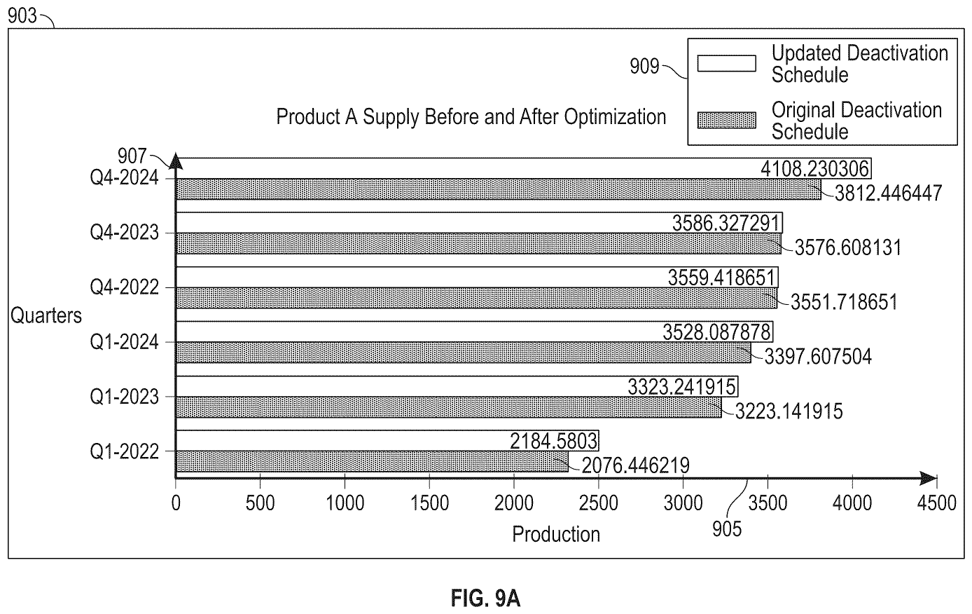

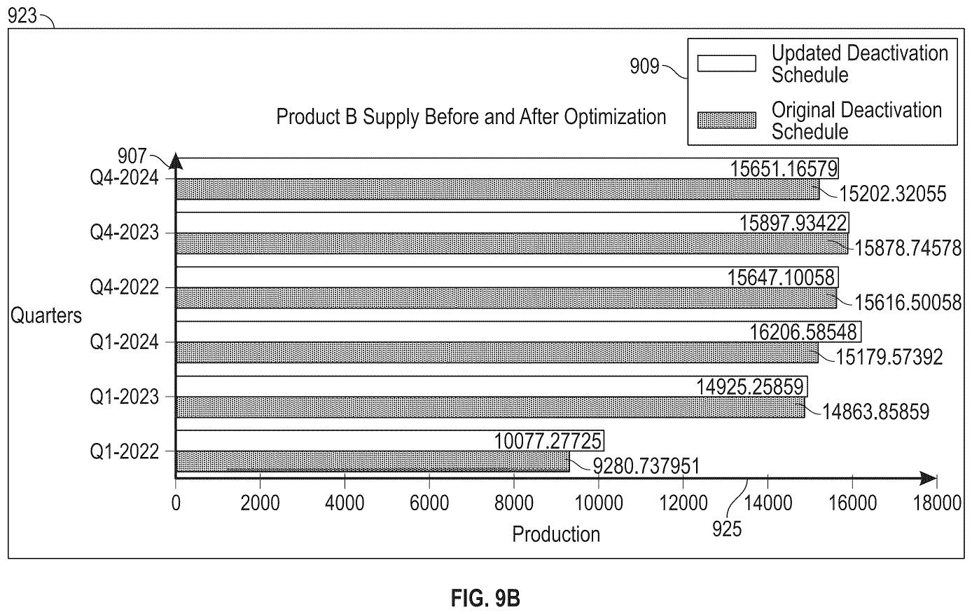

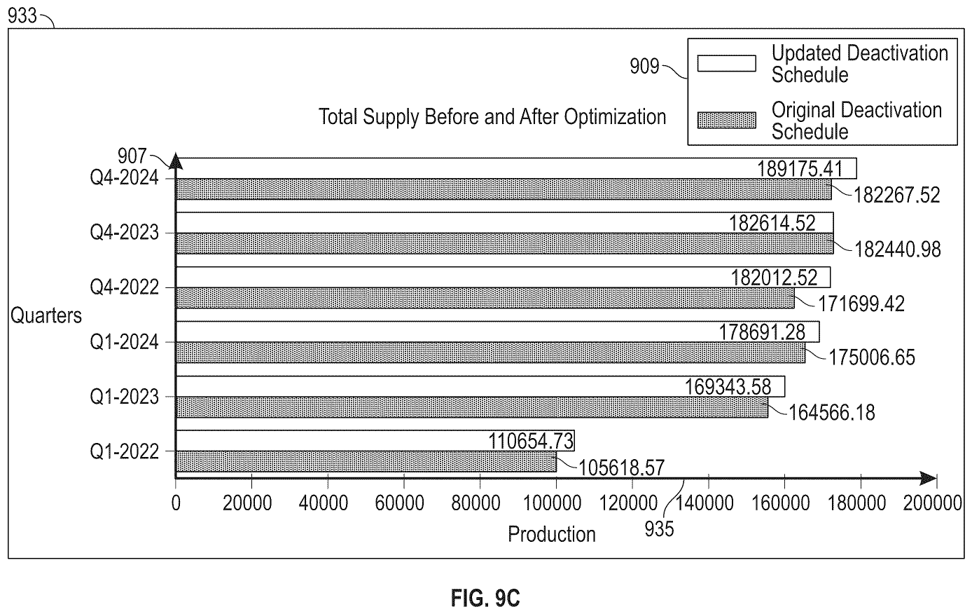

FIG. 9A-9C display a hypothetical scenario in which the systems in FIGS. 4-5 and/or method in FIG. 7 are used to optimize the production of a plurality of materials produced by a processing system. In FIGS. 9A-9C, the processing system includes a plurality of oil refineries, each refinery including a plurality of processing devices. The processing system includes a total of 509 processing devices. The processing system is configured to produce m=40 materials, denoted as Mᵢ, for i=1, . . . , 40. Each of the 40 materials is a certain type of oil. The production period is a specific quarter of a year. The productions of the materials are computed over each of six production periods, namely, the first quarter of year 2022 (Q1-2022), the first quarter of year 2023 (Q1-2023), the first quarter of year 2024 (Q1-2024), the fourth quarter of year 2022 (Q4-2022), the fourth quarter of year 2023 (Q4-2023) and the fourth quarter of year 2024 (Q4-2024). The production of each material is simulated using an original deactivation schedule and an updated deactivation schedule, during the six production periods. The original deactivation schedule is obtained based on an experience of a team of specialists. The updated deactivation schedule is computed as the optimum deactivation schedule (317) using a specific example implementation of the systems in FIG. 3-5.

In this specific implementation, a single production objective function is defined as the sum of the mismatches between production and demand of each material as defined by EQ. 4. The single production objective function defines a first objective function:

$$\\ \begin{matrix}{J}_{1} ( S ) = {{\sum }_{i = 1}}^{40} max ( {d}_{i} - {P}_{i} ( S ) , 0 ) , & EQ . 36\end{matrix}$$

where, for each i=1, . . . , 40, dᵢ is a demand for the material Mᵢ and Pᵢ(S) is the production of the material Mᵢ, based on the deactivation schedule. The mismatch in EQ. 36 is configured as an attempt for the production Pᵢ(S) to, at least, meet the demand dᵢ. The mismatch in EQ. 36 is configured to allow the production Pᵢ(S) to exceed the demand dᵢ. The set of hard constraints includes the deactivation period condition (313), the turnaround condition (314) and a non-overlap requirement for a first set of processing devices, called essential processing devices. The non-overlap requirement prevents pairs of essential processing devices to be deactivated at the same time. A non-overlap preference is defined for a second set of processing devices. The non-overlap preference is a soft constraint, modeled by the first penalization term from EQ. 17. The first penalization term is a second objective function, J₂. The determination of the optimum deactivation schedule (317) includes seeking to minimize the first objective function from EQ. 36, J₁, and the second objective function, J₂. Thus, the determination of the optimum deactivation schedule (317) includes seeking to meet the demand dᵢ for each material Mᵢ while reducing the overlap between the calendared deactivation periods of pairs of processing devices in the second set of processing devices. The optimizer (316) is defined as a multi-stage optimizer from EQ. 28, configured to seek to minimize, sequentially, each of J₁ and J₂.

FIG. 9A displays a first bar chart (903) comparing the simulated production of a first material using the original deactivation schedule and the updated deactivation schedule, during the six production periods. The value of the production is represented on a first abscissa axis (905), in millions of barrels. The production period is indexed on an ordinate axis (907). A legend (909) indicates that the dotted bars represent the simulated production of the first material using the original deactivation schedule, while the unfilled bars represent the simulated production of the first material using the updated deactivation schedule. The first bar chart (903) shows that the simulated production of the first material using the updated deactivation schedule is larger than the simulated production of the first material using the original deactivation schedule for each production period. This may indicate that the systems in FIGS. 3-5 and/or method in FIG. 7 succeed at producing an optimum deactivation schedule (317) that leads to an increase of the production of the first material.

FIG. 9B displays a second bar chart (923) comparing the simulated production of a second material using the original deactivation schedule and the updated deactivation schedule, during the six production periods. The value of the production is represented on a second abscissa axis (925), in millions of barrels. The production period is indexed on the ordinate axis (907). The legend (909) indicates that the dotted bars represent the simulated production of the second material using the original deactivation schedule, while the unfilled bars represent the simulated production of the second material using the updated deactivation schedule. The second bar chart (923) shows that the simulated production of the second material using the updated deactivation schedule is larger than the simulated production of the second material using the original deactivation schedule for each production period. This may indicate that the systems in FIGS. 3-5 and/or method in FIG. 7 succeed at producing an optimum deactivation schedule (317) that leads to an increase of the production of the second material.

FIG. 9C displays a third bar chart (933) comparing the simulated total production of the m materials using the original deactivation schedule and the updated deactivation schedule, during the six production periods. The simulated total production of the m materials is defined as the sum of the simulated productions of the m materials. The value of the production is represented on a third abscissa axis (935), in millions of barrels. The production period is indexed on the ordinate axis (907). The legend (909) indicates that the dotted bars represent the simulated total production of the m materials using the original deactivation schedule, while the unfilled bars represent the simulated total production of the 40 materials using the updated deactivation schedule. The third bar chart (933) shows that the simulated total production of the 40 materials using the updated deactivation schedule is larger than the simulated total production of the 40 materials using the original deactivation schedule for each production period. This may indicate that the systems in FIGS. 3-5 and/or method in FIG. 7 succeed at producing an optimum deactivation schedule (317) that leads to an increase of the total production of the 40 materials.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining, for each processing device of a plurality of processing devices of a processing system, a minimum deactivation time associated with the processing device, wherein the processing system is configured to:
produce one or more materials, and
operate in accordance with a deactivation schedule comprising, for each processing device in the plurality of processing devices, a calendared deactivation period associated with the processing device, during which the processing device is deactivated;
obtaining a maximum turnaround time for the processing system;
obtaining, for the deactivation schedule, a set of conditions comprising:
a deactivation period condition that, for each processing device in the plurality of processing devices, a duration of the calendared deactivation period of the processing device is no less than the minimum deactivation time associated with the processing device;
a turnaround condition that a total duration of the deactivation schedule does not exceed the maximum turnaround time, and
a stateful non-overlap condition that, at least, reduces overlap between calendared deactivation periods;
determining, subject to the set of conditions, an optimum deactivation schedule for the processing system, the determination comprising optimizing a production objective based on a production of the one or more materials, and
performing a system maintenance of the processing system according to the optimum deactivation schedule.

2. The method of claim 1, wherein the production depends on the deactivation schedule.

3. The method of claim 1, wherein optimizing the production objective comprises seeking to maximize a production of each material in a subset of the one or more materials.

4. The method of claim 1, wherein optimizing the production objective comprises:
obtaining a demand for each material in a subset of the one or more materials, and
seeking to minimize, for each material in the subset, a mismatch between a production of the material and the demand for the material.

5. The method of claim 1, wherein the set of conditions comprises a set of hard constraints comprising one or more of:
a non-overlap requirement that optimum calendared deactivation periods associated with pairs of processing devices in a first subset of processing devices do not overlap, the stateful non-overlap condition comprising the non-overlap requirement, and
a minimum gap requirement that a gap between the optimum calendared deactivation periods associated with pairs of processing devices in a second subset of processing devices be at least equal to a minimum gap associated with the pair, the method further comprising obtaining the minimum gap for each pair.

6. The method of claim 1, wherein the set of conditions comprises a set of one or more soft constraints, comprising one or more of:
a non-overlap preference comprising seeking to minimize overlaps between calendared deactivation periods associated with pairs of processing devices in a first subset of processing devices, the stateful non-overlap condition comprising the non-overlap preference, and
a minimum gap preference comprising, for pairs of processing devices in a second subset processing devices:
obtaining, for each pair, a minimum gap associated with the pair, and
seeking to space the calendared deactivation periods associated with the processing devices in each pair by at least the minimum gap associated with the pair.

7. The method of claim 6, wherein determining the optimum deactivation schedule further comprises optimizing a plurality of objective functions comprising, for each soft constraint in the set of one or more soft constraints, a penalization associated with the soft constraint.

8. The method of claim 1, wherein determining the optimum deactivation schedule further comprises optimizing a plurality of objective functions using an optimizer comprising one of:
a multi-objective optimizer;
a sequential optimizer comprising a sequence of stages, each stage associated with a distinct objective function among the plurality of objective functions, and
a single-objective optimizer configured to combine the plurality of objective functions.

9. The method of claim 8, wherein the optimizer comprises one of:
a linear programing algorithm;
a lexicographic algorithm;
a Lagrange multiplier algorithm, and
a genetic algorithm.

10. The method of claim 1, wherein:
the processing system comprises one or more of:
a refinery;
a gas processing plant, and
a chemical plant, and
the system maintenance of the processing system comprises one or more of:
an inspection of each processing device in the processing system, and
a repair of a processing device of the processing system.

11. A system, comprising:
a processing system comprising a plurality of processing devices, the processing system configured to:
produce one or more materials, and
operate in accordance with a deactivation schedule comprising, for each processing device in the plurality of processing devices, a calendared deactivation period associated with the processing device, during which the processing device is deactivated;
a computer comprising one or more computer processors, configured to:
receive, for each processing device of the plurality of processing devices, a minimum deactivation time associated with the processing device;
receive a maximum turnaround time for the processing system;
receive, for the deactivation schedule, a set of conditions comprising:
a deactivation period condition that, for each processing device in the plurality of processing devices, a duration of the calendared deactivation period of the processing device is no less than the minimum deactivation time associated with the processing device;
a turnaround condition that a total duration of the deactivation schedule does not exceed the maximum turnaround time, and
a stateful non-overlap condition that, at least, reduces overlap between calendared deactivation periods, and
determine, subject to the set of conditions, an optimum deactivation schedule for the processing system, the determination comprising optimizing a production objective based on a production of the one or more materials, and
a service system configured to perform a system maintenance of the processing system according to the optimum deactivation schedule.

12. The system of claim 11, wherein the production depends on the deactivation schedule.

13. The system of claim 11, wherein optimizing the production objective comprises seeking to maximize a production of each material in a subset of the one or more materials.

14. The system of claim 11, wherein optimizing the production objective comprises:
obtaining a demand for each material in a subset of the one or more materials, and
seeking to minimize, for each material in the subset, a mismatch between a production of the material and the demand for the material.

15. The system of claim 11, wherein the set of conditions comprises a set of hard constraints comprising one or more of:
a non-overlap requirement that optimum calendared deactivation periods associated with pairs of processing devices in a first subset of processing devices do not overlap, the stateful non-overlap condition comprising the non-overlap requirement, and
a minimum gap requirement that a gap between the optimum calendared deactivation periods associated with pairs of processing devices in a second subset of processing device be at least equal to a minimum gap associated with the pair, the computer further configured to receive the minimum gap for each pair.

16. The system of claim 11, wherein the set of conditions comprises a set of one or more soft constraints, comprising one or more of:
a non-overlap preference comprising seeking to minimize overlaps between calendared deactivation periods associated pairs of processing devices in a first subset of processing devices, the stateful non-overlap condition comprising the non-overlap preference, and
a minimum gap preference comprising, for pairs of processing devices in a second subset processing devices:
obtaining, for each pair, a minimum gap associated with the pair, and
seeking to space the calendared deactivation periods associated with the processing devices in each pair by at least the minimum gap associated with the pair.

17. The system of claim 16, wherein determining the optimum deactivation schedule further comprises optimizing a plurality of objective functions comprising, for each soft constraint in the set of one or more soft constraints, a penalization associated with the soft constraint.

18. The system of claim 11, wherein determining the optimum deactivation schedule further comprises optimizing a plurality of objective functions using an optimizer comprising one of:
a multi-objective optimizer;
a sequential optimizer comprising a sequence of stages, each stage associated with a distinct objective function among the plurality of objective functions, and
a single-objective optimizer configured to combine the plurality of objective functions.

19. The system of claim 18, wherein the optimizer comprises one of:
a linear programing algorithm;
a lexicographic algorithm;
a Lagrange multiplier algorithm, and
a genetic algorithm.

20. The system of claim 11, wherein:
the processing system comprises one or more of:
a refinery;
a gas processing plant, and
a chemical plant, and
the system maintenance of the processing system comprises one or more of:
an inspection of each processing device in the processing system, and
a repair of a processing device of the processing system.
